(19) United States
(12) Patent Application Publication
(10) Pub. No.: US 2026/0105575 A1
(43) Pub. Date: Apr. 16, 2026

(54) VISUAL REPRESENTATIONS OF SAMPLE CARRIERS

(71) Applicant: Dionex Softron GmbH, Germering (DE)

(72) Inventors: Christoph Hollnagel, Germering (DE); Til Richardsen, Kirchseeon (DE); Tobias Metz, Buch (DE)

(21) Appl. No.: 18/913,786

(22) Filed: Oct. 11, 2024

(51) Int. Cl. G06T 5/50; G06T 5/80

(52) U.S. Cl. CPC G06T 5/50; G06T 5/80; G06T 2207/20221

(57) ABSTRACT

The present invention relates to a method comprising capturing image data with an imaging component, the imaging component configured with a field of view towards a placement area of a platform component, the placement area configured to hold a sample carrier and processing the image data with a processing component. The present invention also relates to a system comprising corresponding features.

The invention relates to generating visual representations of sample carriers, preferably liquid sample carriers, particularly used in the field chromatography, preferably liquid chromatography, more preferably, High-Performance Liquid Chromatography (HPLC).

### BACKGROUND

Chromatography, such as HPLC, is an analytical method that enables the separation of a sample into its components to quantify their respective amounts. One component used in chromatography systems is a sampler, which is typically responsible for sample management and accurate sample drawing from sample vials. After sample drawing, the sampler, using switching valves, introduces the sample into an analytical flow path wherein the sample undergoes chromatographic analysis. Each run, i.e., chromatography analysis, may be performed with different samples, i.e., with different sample vials. For example, a first sample vial may be used for a first sample run, a second sample vial may be used for a second sample run, etc. Thus, different samples may be analyzed in sequence, and a list of this sequence may be referred to as a sequence list, or for simplicity as a sequence.

Typically, samples are provided inside sample vials which are loaded into sample carriers, e.g., sample racks, either manually or, for example, in automated chromatography systems, with automated loaders. Labelling individual sample vials with barcodes increases traceability of each sample, even in the case of incorrect sorting into the sample rack. Even with automated samplers, there is a demand for reassurance that the correct samples have been analyzed.

Currently, users must remember the positions of sample vials within the sample rack and manually enter them into the sequence. A picture or view of the interior of the sampler may facilitate a simpler and more secure selection of only occupied sample positions within the sample rack. This also enables further automation of these steps and sequence monitoring. There is also a desire for remote control of sampler loading from a remote location.

In the current general state of the art, sample loading in the sampler is typically monitored on-site through a door or a viewing window in the sampler towards the sample rack. The absence of sample vials may be detected by scanning with a sensor, e.g., in the needle arm which is used to draw the sample from the sample vial. For the selection of occupied sample positions in sequence generation, the user needs to know which positions have been loaded and note this information somewhere.

Currently, it is generally not possible to look into the sampler from a distance, and sequence generation must be done blindly without seeing the sample rack inside the sampler. Finding empty positions takes time and can typically only be done during the sequence execution. The subsequent behaviour is then unclear—the sequence may be aborted or the missing sample may be skipped. There is always the risk that a sample will not be analysed or will be analysed with the wrong method since an analysis method has already been assigned to a specific position in the sequence.

In controlled environments, rework and verification are usually necessary to ensure that the missing sample positions were correctly skipped and that all samples were analysed correctly. Since sample racks are often manually loaded with small, sometimes customer-specific vials, errors can occur, such as missing samples vials or vials without lids or loose vials lying in the sample area. To detect such errors or ensure that they are not present, the user must approach the sampler to check the condition of the sample area, which can be very time-consuming.

JP6048584B2/U.S. Pat. No. 10,191,620B2 describes an HPLC system with an auto-sampler capable of taking an image of a tray from above. This image is then presented to the user alongside a graphical representation of the tray to facilitate the selection of the correct vials.

Currently, looking into the sampler from a distance is not possible. Someone must go to the device to check the condition of the sample area. The absence of the sample is generally detected only during the sequence, not in advance, and not for an entire tray at once.

This present invention mitigates these drawbacks and provides additional analysis possibilities and customer benefits.

The present invention relates to a method comprising capturing image data with an imaging component. The imaging component is configured with a field of view towards a placement area of a platform component. The placement area is configured to hold a sample carrier. The method further comprises processing the image data with a processing component.

The present invention may thus enable viewing the platform component, in particular the sample carrier(s) positioned thereon, digitally. This capability can be offered by the image data captured by the imaging component. In turn, this can facilitate monitoring the platform component, in particular the sample carrier, remotely. That is, the present invention alleviates the need of on-site monitoring of the platform component, in particular the sample carrier(s) positioned thereon.

Additionally, the present invention may facilitate providing the digital view of the platform component, in particular of the sample carrier(s) positioned thereon, on-demand. Therefore, the present invention may enable on-demand inspection and monitoring of the platform component, in particular of the sample carrier(s) positioned thereon, without the need of physically approaching the platform component. This may encourage users to view the sample carrier(s) more frequently, particularly when implementing routines for processing the samples thereof. As a result, a more accurate processing of the sample carried by the sample carriers can be achieved. In particular, the risk that a sample in a sample carrier is not analyzed or is analyzed correctly can be reduced. As a further result, the likelihood of detecting errors may be increased.

Furthermore, processing the image data can be advantageous as the saliency of the sample carrier(s) may be increased, which may make it more ergonomic for the user to inspect and monitor them. This can be particularly advantageous given that the platform component is generally provided in a confined space, which may necessitate positioning the imaging component within a close distance from the platform component. As a result, the raw image data as captured by the imaging component may depict a distorted view of the platform component and of the sample carrier(s) positioned thereon. Processing the image data may allow for such distortions to be mitigated, hence providing a clearer view. In turn, this makes it more likely that the platform component and the sample carrier(s) are inspected correctly.

Further still, processing the image data may allow for augmentation of the digital view of the platform component and the sample carrier(s) thereon. This may further increase ergonomics of inspecting and monitoring them.

All in all, the present invention may enable users to remotely view the platform component in a simple way, thus aiding the users in determining the occupancy of the platform component with sample carrier(s) as well as in detecting errors. The present invention may provide these advantages despite the confined space wherein platform components may typically be positioned.

The method can comprise detecting, with the processing component and on the captured image data, the shape of at least one surface, preferably a top surface, of the sample carrier disposed on the placement area.

The method can comprise determining with the processing component a sample carrier characteristic of the sample carrier.

The sample carrier can comprise a plurality of sample vial receptacles, wherein each sample vial receptacle may be configured to hold a sample vial. The sample vial receptacle may also be interchangeably referred to as a vial position. It will be understood, that the sample vial receptacle, i.e., a vial position, may be occupied and thus holding a sample vial or it may be unoccupied, i.e., empty and thus not holding a sample vial.

The sample carrier characteristic may be indicative of a shape of the sample carrier.

The sample carrier characteristic may be indicative of a shape of a top surface of the sample carrier.

The sample carrier characteristic may be indicative of a distribution of the sample vial receptacles.

The sample carrier characteristic may be indicative of number of sample vial receptacles.

The sample vial receptacles may be evenly distributed on a top surface of the sample carrier.

The method can comprise moving the platform component relative to the imaging component according to a motion. It will be understood that said motion may be continuous or stepwise. The stepwise motion may include a plurality of sub-motions with pauses therebetween.

Said motion may be rotation of the platform component relative to the imaging component around a rotation axis parallel to a surface normal of the placement area.

The method can comprise capturing with the imaging component images during motion of the platform component. In case of a continuous motion, the images may be captured while the platform component is moving. In this case it may be advantageous to capture the images with a short exposure time to thereby reduce motion blur. In case of a stepwise motion, the images may be captured between the sub-motions, i.e., during the pauses therebetween. This mitigates motion blur and may allow for longer exposure times. It will be understood that capturing with the imaging component images during motion of the platform component may encompass any of the above implementations.

The imaging component may be disposed at a predetermined height above the platform component. Typically, the available positions in which the imaging component can be placed may be limited due to the confined space in which the platform component may be located.

The predetermined height may be at most 700 mm, preferably at most 600 mm, more preferably at most 550 mm from the top surface of the platform component. Again, said height may be restricted by the confined space in which the platform component may be located.

It will be understood that this is only exemplary and that the imaging component may be placed elsewhere. For example, mirrors may be used to create an optical path between the imaging component and the platform component.

The imaging component may be disposed spaced apart from a central axis, preferably a rotation axis, of the platform component. This may increase the portion of the platform component and in particular of the sample carrier(s) thereon that are captured undistorted. In particular, it can facilitate obtaining a uniform and consistent perspective view over all or at least a large number of sample vials in the field of view of the imaging component.

The imaging component may be disposed within a radial interval.

Said radial interval may be defined by the rotation axis of the platform component and an outer most rotating point of the placement area. That is, the radial interval may extend from the rotation axis of the platform component to the outer most rotating point of the placement area.

Preferably, the radial interval may be defined by an inwardly facing end of the sample carrier and an outwardly facing end of the sample carrier. The inwardly facing end of the sample carrier may herein refer to an end of the sample carrier being closest to the central axis of the platform component. The outwardly facing end of the sample carrier may herein refer to an end of the sample carrier being furthest from the central axis of the platform component.

More preferably, the radial interval may be defined by an inwardly facing end of the sample carrier and a vertical central axis of the sample carrier.

A radial position of the imaging component with respect to the rotation axis of the placement area may coincide with a radial position of at least one radially inner most sample vial receptacle of the plurality of sample vial receptacles with respect to the rotational axis. The radial position may be indicative of a distance from the rotation axis. The radially inner most sample vial receptacle may herein refer to a sample vial being closest to the central axis of the platform component.

A radial distance between the imaging component and an inwardly facing end of the sample carrier may be less than half of a distance between the inwardly facing end and an outwardly facing end of the sample carrier.

That is, the imaging component can be provided above an inner half of the sample carrier. The inner half of the sample carrier may herein refer to the half of the sample carrier being closest to the central axis of the platform component.

A radial distance between the imaging component and an inwardly facing end of the sample carrier may be measured perpendicularly to the rotational axis.

The imaging component may be disposed such that it can comprise a substantially uniform perspective on at least some of the plurality of sample vial receptacles and/or on at least some of the sample vials disposed within the sample vial receptacles.

An imaging plane of the imaging component may be parallel to the placement area. That is, an optical axis of the imaging component may be perpendicular to the placement area.

Alternatively, an imaging plane of the imaging component may be angled with respect to the placement area. That is, an optical axis of the imaging component may intersect the placement area at an angle different from 90°.

The method can comprise correcting, with the processing component, optical distortions of the image data. As discussed, this may increase the saliency of the platform component and of the sample carrier(s) thereon and thus aid the user in inspecting and monitoring them.

Correcting optical distortions of the image data can comprise using intrinsic camera parameters of the imaging component. Intrinsic camera parameters, which may also be referred to as camera intrinsics, may be indicative of a focal length, an optical center and/or a lens distortion coefficient of the imaging component. Types of optical distortions that may be corrected may comprise radial distortions, i.e., straight lines appearing as curved lines and/or tangential distortions. Correcting the optical distortions may comprise remapping pixels in the image data so that distorted points can be transformed to their correct positions.

The method can comprise executing with the processing component a camera calibration algorithm to determine the intrinsic camera parameters of the imaging component. This may comprise capturing images of a known pattern (e.g., a checkerboard) from different angles and distances.

Correcting the optical distortions of the image data can comprise performing perspective correction based on the angle of the imaging plane relative to the top surface of the sample carrier.

Correcting optical distortions of the image data can comprise performing distortion correction based on the optical properties of the imaging component.

Processing the image data can comprise generating a top view representation of the sample carrier. The top view representation of the sample carrier may be generated such that it depicts an undistorted top view of the sample carrier.

The correcting of the optical distortions of the image data may be performed prior to generating the top view representation of the sample carrier. This way little to no optical distortion may be present in the top view representation of the sample carrier.

The method can comprise the processing component separating the sample carrier from the placement area and/or from background to generate the top view representation of the sample carrier.

Generally, it will be understood that in embodiments of the present invention, the processing component may also comprise a displaying component, e.g., a monitor, and the processing component may thus also be configured to display information to a user, e.g., the top view representation and/or the vial receptacle image, which will be referred to below.

Capturing the image data can comprise capturing an image sequence comprising a plurality of images, and wherein each image of the image sequence depicts a section of the placement area. This can particularly be advantageous if the field of view of the imaging component is smaller than the platform component. Thus, a single image may not capture the entire platform component. However, by capturing an image sequence wherein each image thereof depicts a section of the placement area may facilitate generating image data corresponding to the entire platform component.

The method can comprise capturing the image sequence during motion of the platform component. Therefore, different sections of the placement area may be positioned in the field of view of the imaging component.

Each image of the image sequence may depict a different section of the placement area.

For at least two of the images of the image sequence, the respective sections of the platform component depicted thereon partially overlap. This may facilitate determining a spatial arrangement of the images relative to each other and in particular stitching operation thereafter.

Each section of the placement area may be at least represented once within the image sequence. In other words, the image data may completely cover the placement area.

The method can comprise extracting with the processing component image sections from the image sequence, preferably extracting with the processing component an image section from each of at least some images of the image sequence. The image sections may refer to a usable part of each image. An image section may be selected within an image such that it corresponds to a least distorted part of the image.

At least some of the image sections, preferably each image section, may be a circular sector.

Each circular sector may have the rotation axis at its circle center. However, it will be understood that this is only exemplary.

Each circular sector may have an angle smaller than 10°, preferably smaller than 8°, further preferably smaller than 5°. Generally, smaller angles may be preferable as they may allow better mitigating distortions. Larger segments may lead to a higher distortion at the stitching regions.

The method can comprise extracting with the processing component the image sections in relation to a central point or the central axis of the placement area, preferably a rotation axis, of the platform component.

At least some of the image sections may be rectangular, preferably strip-shaped.

Each image section may be radially aligned with a central axis, preferably a rotation axis, of the platform component.

Each of the image sections may depict equally sized subsections of the placement area.

The image sections may be of equal size.

The method can comprise combining with the processing component the image sections and based thereon generating an overview image. The overview image may be generated such that it depicts an undistorted top view of the placement area.

The overview image can comprise a cohesive image of all sample carriers disposed on the placement area.

The overview image can comprise a cohesive image of the complete placement area and of all sample carriers disposed on the placement area.

For example, the overview image can comprise a photographic representation of the placement area comprising sampler carriers.

Correcting of the optical distortions of the image data may be performed prior to generating the overview image. This way little to no optical distortion may be present in the overview image.

The overview image may be a two-dimensional top view. This may make it particularly easy to determine occupied and unoccupied sample vial receptacles as well as to determine whether the sample vials comprise a lid or not.

The platform component can comprise at least one platform tracking indicator, and wherein the method can comprise indicating, with the platform tracking indicator, a position and/or an orientation of the platform component with respect to the field of view of the imaging component. This may facilitate generating the top view representation and/or the overview image. In particular, knowledge about the relative position and/or orientation of the platform component and the imaging component may facilitate a stitching of the image sections.

The placement area can comprise at least one placement tracking indicator, and wherein the method can comprise indicating, with the placement tracking indicator, a position and/or an orientation of the placement area with respect to the field of view of the imaging component.

The sample carrier can comprise at least one carrier tracking indicator, and wherein the method can comprise indicating, with the carrier tracking indicator, a position and/or an orientation of the sample carrier with respect to the field of view of the imaging component.

The method can comprise indicating, with an indicator component, a position indicator signal to the processing component and/or to the imaging component, said position indicator signal indicating the relative position of the platform component and/or of the placement area to the imaging component.

The indicator component can comprise at least one visual indicator which can be disposed within the field of view of the imaging component. The at least one visual indicator may indicate an orientation and/or position of the platform component and/or the placement area. For example, multiple visual indicators may be used, each indicative of a respective orientation and/or position of the platform component and/or the placement area. Alternatively or additionally, the orientation of the at least one visual indicator may correspond to an orientation of the platform component and/or the placement area. The at least one visual indicator may be positioned on the platform component, placement area and/or the sample carrier.

The method can comprise aligning, with the processing component, the image sections according to the platform tracking indicator, placement tracking indicator, carrier tracking indicator and/or position indicator.

The method can comprise moving, with a motion component, the platform component.

The method can comprise moving, preferably rotating, with the motion component, the platform component in relation to the imaging component to modify a section of the placement area in the field of view of the imaging component. Information about the motion produced by the motion component may be used to align, with the processing component, the image sections. For example, the motion component may be instructed to rotate by “15°”. These instructions may be used to infer the relative orientation between the platform component and the imaging component.

The method can comprise moving, with the motion component, the platform component step-wise and wherein with each step, the placement area section within the field of view of the imaging component may be modified, preferably moved by a predetermined distance along a predetermined trajectory, preferably a circular trajectory.

The method can comprise rotating, with the motion component, the platform component around the rotation axis.

The method can comprise performing, with the motion component, a step-wise movement sequence of the platform component comprising a sequence of predetermined, preferably alternating, movement intervals and stop intervals.

Capturing the image sequence can comprise capturing, with the imaging component, an image during a stop interval, preferably an image during each stop interval and wherein the images captured during the stop intervals form the image sequence. This can mitigate motion blur that may otherwise be present.

The method can comprise synchronizing, with the processing component, the motion component with respect to the imaging component to acquire image data during stop intervals.

The method can comprise adjusting, with the processing component, a duration of the stop interval according to an image capture time required by the imaging component to capture an image.

The method can comprise adjusting, with the processing component, the duration of the stop interval according to an inertia component of the movement of the platform component.

The method can comprise capturing, with the imaging component, the sample carrier disposed on the placement area with the image sequence, in particular capture the sample carrier completely.

The method can comprise capturing, with the imaging component, the sample carrier with a height of up to a predetermined maximum height.

The method can comprise determining, with the processing component, fill status characteristics, each indicative of the presence of a sample vial in a corresponding sample vial receptacle. That is, the processing component may determine for each sample vial receptacle of the sample carrier a respective fill status characteristic that indicates whether the sample vial receptacle is occupied with a sample vial.

The method can comprise determining, with the processing component, a respective fill status characteristic for each sample vial receptacle.

The method can comprise determining, with the processing component, vial characteristics, each indicative of a property of a corresponding sample vial disposed in the sample carrier.

The method can comprise determining, with the processing component, a respective vial characteristic for each sample vial disposed in the sample carrier.

Each vial characteristic may be indicative of at least one of the following: presence of a vial lid; presence of a vial cap; presence of a specific marking of the sample vial; presence of a septum; color of the vial; color of the vial lid; color of the sample comprised with the vial; shape of the vial, in particular a cross-section and/or a shape of the vial opening; volume of the vial; length of the vial; fill status of the vial with respect to a sample; position of the sample vial within the sample vial receptacle; orientation of the sample vial within the sample vial receptacle; relative position of the sample vial with respect to the sample carrier; relative position of the sample vial with respect to a spatial configuration of sample vial receptacles; a marker of the sample vial, in particular a marker on a top side of the sample vial.

The vial characteristic may aid in inspecting the sample carrier.

The method can comprise generating, with the processing component, a carrier schematic comprising a schematic representation of the sample carrier. The schematic representation may include a simplified view of the sample carrier with selected information displayed and/or highlighted. Therefore, inspection of the sample carrier may be quicker and simpler. That is, the carrier schematic may provide information about the sample carrier in an ergonomically improved manner.

The carrier schematic can comprise an outline of the sample carrier and/or an outline of the sample vial receptacles. That is, the carrier schematic may indicate the general structure of the sample carrier and/or of the sample vial receptacles. Therefore, the sample carrier and/or sample vial receptacles may be easily identified in the carrier schematic.

The carrier schematic may be indicative of the geometry of the sample carrier.

The method can comprise generating, with the processing component, the carrier schematic by processing the image data.

The method can comprise generating, with the processing component, the carrier schematic by processing the top view representation of the sample carrier. It may be easier and more computationally efficient to generate the carrier schematic from the top view representation, as compared to generating it from the raw image data. As explained, the top view representation may already provide a clearer and undistorted or little distorted view of the sample carrier.

The method can comprise generating, with the processing component, the carrier schematic based on a user input. For example, the user input may be indicative of a type of the sample carrier and the carrier schematic may be generated based thereon.

The method can comprise generating, with the processing component, the carrier schematic by accessing a database of carrier schematics and selecting the carrier schematic in the database of carrier schematics. User input indicative of a type of the sample carrier may be used for selecting the carrier schematic in the database of carrier schematics.

Selecting the carrier schematic in the database of carrier schematics can comprise using a carrier label, said carrier label preferably being indicative of a type or ID of the sample carrier. The carrier label may, for example, be attached on the sample carrier and visible to the imaging component.

The method can comprise detecting on the image data, with the processing component, the carrier label associated with the sample carrier.

The method can comprise augmenting, with the processing component, the carrier schematic with at least one of the vial characteristics and generating based thereon an augmented carrier schematic. The augmented carrier schematic may thus provide in an ergonomically improved manner information about the sample carrier, and in particular about the vials therein. This may particularly facilitate the inspection of the sample carrier.

The method can comprise augmenting, with the processing component, the carrier schematic with a vial characteristic for each detected sample vial.

The method can comprise providing, with the processing component, the augmented carrier schematic as a basis for a sequence creation, such as a puncture sequence.

The method can comprise toggling, with the processing component, between providing the overview image and the carrier schematic, preferably the carrier schematic augmented with vial characteristics, to enable a comparison between generated schematics and the photographic representation of the placement area comprising the sample carrier. The user may thus switch between the overview image and the carrier schematic. This may allow the user to verify and/or complement information provided by the carrier schematic by looking at the overview image.

The method can comprise generating, with the processing component, a schematic view depicting the carrier schematic.

The schematic view may further depict, preferably schematically, the fill status characteristics associated with each corresponding sample vial receptacle.

The schematic view may further depict, preferably schematically, the vial characteristics associated with each corresponding sample vial disposed in the sample carrier.

The method can comprise displaying the schematic view on a display device that may be operatively connected to the processing component.

The method can comprise displaying, preferably simultaneously, on the display device the schematic view and a sequence list input interface, wherein the sequence list input interface allows a user to input a sequence list indicative of an ordered list of sample vials of the plurality of sample vials disposed in the sample carrier. Therefore, the samples can be analyzed according to the intended order.

For example, the system may be part of a chromatography system, e.g., a liquid chromatography system. That is, the liquid chromatography system may can comprise the system described. In such a liquid chromatography system, runs may be performed with different samples, i.e., with different sample vials. For example, a first sample vial may be used for a first sample run, a second sample vial may be used for a second sample run, etc. Thus, different samples may be analyzed in sequence, and a list of this sequence may be referred to as a sequence list.

The position within the ordered list may determine the running order of the sequence.

The method can comprise generating, with the processing component, vial receptacle images, each depicting a top view of a respective sample vial receptacle. The vial receptacle image may thus provide a more detailed and/or zoomed-in view of a single vial receptacle, i.e., vail position. Therefore, each vial receptacle may be inspected in isolation and on-demand.

The method can comprise processing, with the processing component, the vial receptacle images to enhance the visual depiction thereon of the fill status characteristics and/or of the vial characteristics. Therefore, information regarding each vial receptacle may be more easily obtained.

The method can comprise cutting, with the processing component, the vial receptacle images from the image data and/or from the image sections of and/or from the overview image of, preferably using a mask, more preferably a positive mask, even more preferably a positive mask with a circular shape. Therefore, the vial receptacles images may comprise little to no distortion.

The method can comprise displaying on the display device, preferably upon being prompted by a user, the vial receptacle images. That is, the vial receptacle images may be displayed on-demand.

The method can comprise selectively displaying the vial receptacle images one at a time depending on a prompt provided by a user. This may allow the user to scroll through the vial receptacle images.

The method can comprise displaying each vial receptacle image overlayed on the carrier schematic, preferably overlayed over the corresponding sample vial receptacle. Thus, on the one hand the vial receptacle images show each sample vial receptacle accurately and clearly, and on the other hand unimportant information may be omitted by showing the carrier schematic instead of the actual image of the sample carrier.

The method can comprise incorporating, with the processing component, at least one of the vial receptacle images into the carrier schematic.

The method can comprise incorporating, with the processing component, a plurality of the vial receptacle images into the carrier schematic, wherein each vial receptacle image relates to a separate sample vial receptacle.

The method can comprise generating, with the processing component, a fill level schematic comprising a schematic representation of the fill status characteristics and incorporating, with the processing component, the fill schematic into the carrier schematic.

The method can comprise determining, with the processing component, a confidence threshold of the carrier schematic representing the actual status of the sample carrier and providing, with the processing component, the image data and/or the top view representation to a user interface when the confidence threshold falls below a predetermined lower confidence threshold value. This may indicate to the user when automatic detection lacks accuracy, which may serve as an incentive for the user to verify the information, e.g., by looking at the top-view representation, overview image and/or the respective vial receptacle image. Overall, this may increase accuracy and may mitigate errors associated with automatic detection of features of the sample carrier.

The method can comprise overlaying, with the processing component, the carrier schematic with the vial receptacle images and/or with the top view representation of the sample carrier. This may facilitate verifying that the information indicated by the carrier schematic is correct.

The method can comprise displaying the overview image on the display device.

The method can comprise overlaying, with the processing component, the top view representation of the sample carrier with the carrier schematic and/or the vial receptacle images.

The method can comprise generating, with the processing component, a carrier schematic for each sample carrier present on the placement area.

That is, the present invention may also encompass the presence of multiple sample carriers on the placement area. In such embodiments, the processes performed and discussed with respect to the sample carrier may be similarly performed for each sample carrier on the placement area. For example, a respective top view representation and/or a respective carrier schematic may be generated for each sample carrier on the placement area.

The method can comprise overlaying, with the processing component, for each sample carrier present on the placement area, the respective carrier schematic with a respective top view representation of the sample carrier.

The method can comprise providing, with the processing component, a combined image comprising the overview image and the carrier schematics, preferably by either juxtaposing the overview image with the carrier schematics or by combining and aligning the overview image and the carrier schematics, more preferably the latter.

The method can comprise mapping, with the processing component, a vial geometric shape, preferably a vial geometric shape of a plurality of vial geometric shapes, to a sample vial based on the vial characteristic.

The method can comprise performing, with the processing component, at least one of the following image analyses to determine the vial characteristic: a brightness contrast detection, a color contrast detection; an edge detection on the image data on the image data, sharpening, and/or smoothing or blurring.

The method can comprise, executing, with the processing component, a neural network and wherein the neural network may be trained based on a learning sequence comprising platform component data, placement area data and/or sample carrier data.

The neural network may be trained to determine a sample carrier characteristic and/or a vial characteristic.

The platform component data may relate to geometric properties of the platform component, preferably in the form of an image representation of a platform component, more preferably in the form of a plurality of platform component images comprising different platform component geometries.

The placement area data may relate to geometric properties of the placement area, preferably in the form of an image representation of the placement area, more preferably in the form of a plurality of overview images comprising different placement area geometries.

The sample carrier data may relate to geometric properties of the sample carrier, preferably in the form of an image representation of the sample carrier, more preferably in the form of a plurality of sample carrier images comprising different sample carrier geometries.

The image data can comprise a side angle view, such as an oblique view, of the sample carrier and wherein the method can comprise extracting, with the processing component, a code, preferably a graphical code, from the image data.

The placement area and/or the sample carrier can comprise a code.

The image data can comprise a substantially distorted representation of the sample carrier.

The method can comprise overlaying, with the processing component, parts of the carrier schematic over the top view representation and/or the overview image, and providing based thereon an augmented reality representation of the sample carrier. That is, a mixed view may be provided comprises the carrier schematic and the top view representation and/or the overview image.

The method can comprise replacing, with the processing component, sections of the top view representation and/or the overview image with the carrier schematic or at least a segment of the carrier schematic.

The method can comprise displaying, with the processing component, for at least one sample vial in the top view representation and/or in the overview image and/or in the carrier schematic: a sample name, information relating to a processing method corresponding to the sample vial, and/or a position of the sample vial.

The method can comprise receiving, with the processing component, information relating to a geometry of the sample carrier by a user input.

The method can comprise determining, with the processing component, information relating to a geometry of the sample carrier by reading information, e.g., a barcode on the sample carrier.

The method can comprise determining, with the processing component, a sample carrier type corresponding to the sample carrier.

Determining the sample carrier type may be based on a user input, preferably on a user selection of a sample carrier type out of a plurality of reference sample carrier types.

Determining the sample carrier type may be based on a geometrical feature of the sample carrier.

The method can comprise determining, with the processing component, the sample carrier type by comparing the geometrical feature of the sample carrier with reference geometrical features corresponding to reference sample carrier types.

The reference sample carrier types may be stored associated with respective reference geometrical features in a reference database and wherein the method can comprise accessing, with the processing component, the reference database.

The method can comprise generating, with the processing component, a new reference sample carrier type and to associate the new reference sample carrier type with the geometrical feature of the sample carrier, if no matching may be found between the geometrical feature of the sample carrier and the reference geometrical features.

The method can comprise adding, with the processing component, the new reference sample carrier type associated with the geometrical feature of the sample carrier to the reference database.

The method can comprise determining, with the processing component, the geometrical feature of the sample carrier by processing the image data, preferably a portion of the image data corresponding to the sample carrier, such as, the top view representation.

The method can comprise determining, with the processing component, the geometrical feature of the sample carrier by processing the overview image, preferably a portion of the overview image corresponding to the sample carrier.

The method can comprise determining, with the processing component, the geometrical feature of the sample carrier by processing an image of the sample carrier, said image captured while the sample carrier may be empty and wherein the image data can comprise said image.

The geometrical feature can comprise an outline of the sample carrier.

The geometric feature can comprise a vial positional pattern of the sample vial receptacle.

The vial positional pattern may be a 2-dimensional pattern.

The method can comprise determining, with the processing component, the vial positional pattern by determining respective positions, preferably midpoint positions, of at least some of the sample vial receptacle and fitting a pattern to the determined positions.

Fitting the pattern to the determined positions can comprise using algebraic and/or regression analysis.

Fitting the pattern to the determined positions can comprise determining a best-fit pattern from a library of reference patterns.

The method can comprise storing, with the processing component, the vial positional pattern as a new pattern in a library of reference patterns.

The library of reference patterns may be stored in the reference database.

The method can comprise determining, with the processing component, a quality level for the vial positional pattern and automatically associating, with the processing component, the vial positional pattern with the sample carrier if the quality level exceeds a quality threshold level.

The method can comprise displaying, with the processing component, the vial positional pattern, preferably simultaneously with image data representing the sample carrier, and receiving, with the processing component, user input to confirm the vial positional pattern.

The method can comprise determining, with the processing component, a puncture position for a probe needle based on vial positional pattern.

The sample carrier may be a well-plate.

The method can comprise determining, with the processing component, a puncture of a vial, e.g., a sample vial, preferably a puncture of a vial seal, i.e., a septum, in particular a puncture by a probe needle.

The method can comprise adjusting, with the processing component, an image data parameter of the image data to determine a puncture and/or puncture position of the vial.

The image data parameter may be an exposure value, a contrast value, and/or an illumination parameter.

The method can comprise determining the puncture and/or puncture position of the vial based on a contrast difference in the image data.

The method can comprise determining, with the processing component, a position difference between an expected puncture position and a captured puncture position.

The method can comprise adjusting, with the processing component, a puncture position for a subsequent sample carrier and/or subsequent vial based on the position difference, in particular to reduce the position difference.

The method can comprise adjusting, with the processing component, the puncture position if and only if the position difference may be smaller than a difference threshold.

The adjustment of the puncture position may be smaller than the position difference, wherein the adjustment of the puncture difference may be preferably smaller than 80% of the puncture difference, further preferably smaller than 60% of the puncture difference, such as smaller than 40% of the puncture difference.

The method can comprise iteratively determining and/or correcting, with the processing component, the puncture position of a sequence of vials, in particular, adjusting, with the processing component, a puncture position of a subsequent vial based on a determined puncture position of a previous vial.

The method can comprise determining, with the processing component, a plurality of position differences, preferably position differences for a complete sample carrier.

The method can comprise averaging, with the processing component, the plurality of position differences and to determine a puncture position correction for a sample carrier based on the difference average.

The method can comprise determining, with the processing component, a drift, in particular a systematic drift, of puncture positions based on the plurality of position differences.

The method can comprise determining, with the processing component, a wear level based on the position difference.

The method can comprise providing, with the processing component, a warning and/or stopping, with the processing component, a subsequent puncture when the wear level exceeds a predetermined threshold value.

The method can comprise extracting, with the processing component, position marker data from the image data, wherein the position marker data defines at least one puncture position, preferably in relation to the sample carrier, respectively the sample carrier position on the placement area.

The method can comprise setting, with the processing component, a plurality of puncture positions according to the position marker data.

The method can comprise utilizing a calibration target.

The method can comprise disposing the calibration target on the placement area or on the sample carrier.

The image data can comprise at least two representations of the calibration target at different positions relative to the capture component.

The method can comprise determining, with the processing component, a distance and/or displacement vector between the two representations of the calibration target.

The calibration target can comprise at least one uniquely identifiable marker.

The calibration target can comprise at least two uniquely identifiable markers which may be spaced apart relative to one another.

The two representations of the calibration target each can comprise a representation of the at least one uniquely identifiable marker, and wherein the method can comprise determining, with the processing component, a distance and/or displacement vector between the two representations of the uniquely identifiable marker, in particular for each uniquely identifiable marker can comprised in the image data.

The method can comprise calculating, with the processing component, a central perpendicular of the displacement vector, in particular calculating at least two central perpendiculars for two uniquely identifiable markers and their respective displaced representations.

The method can comprise determining, with the processing component, a central point, in particular a rotation axis, of the placement area and/or the platform component from the intersection of two central perpendiculars.

The platform component may be part of an autosampler for a chromatography system, preferably for a liquid chromatography system, more preferably for a high-performance liquid chromatography system.

The present invention also relates to a system comprising a platform component having a placement area configured to hold a sample carrier; an imaging component configured with a field of view towards the placement area and configured to capture image data of at least a part of the placement area; and a processing component configured to process the image data.

The system may be configured to carry out the method according to any of the preceding method embodiments.

The system may comprise corresponding features to the method as discussed above and below. For the sake of brevity, a detailed discussion of these features is omitted herein.

The present invention also relates to an autosampler for a chromatography system, wherein the autosampler can comprise the system according to the present invention.

The present invention also relates to a chromatography system comprising the autosampler.

The present invention also relates to a use of the system according to the present invention, the autosampler according to the present invention and/or the chromatography system according to the present invention in liquid chromatography, preferably in high performance liquid chromatography.

The method can comprise utilizing the system according to the present invention, and/or the autosampler according to the present invention, and/or the chromatography system according to the present invention.

A goal of the present invention may be to enable the user to remotely check the turntable, its occupancy, and the sample racks in a simple, easy to comprehend, intuitive and cognitively ergonomic manner. A goal of the present invention may also be the use of image processing techniques to automatically distinguish occupied from unoccupied positions in a sample carrier and/or detect specific features corresponding to the sample vials, such as presence of a lid in a sample vial. A goal of the present invention may also be to achieve the former goals with images captured in a confined vertical space of an autosampler, such as, of an HPLC autosampler.

The present invention further relates to the following numbered embodiments.

Below, method embodiments will be discussed. These embodiments are abbreviated by the letter “M” followed by a number. Whenever reference is herein made to “method embodiments”, these embodiments are meant.

M1. A method (100) comprising:
capturing image data with an imaging component (104), the imaging component (104) configured with a field of view (114) towards a placement area (102) of a platform component (101), the placement area (102) configured to hold a sample carrier (103); processing the image data with a processing component.

M2. The method according to the preceding embodiment, wherein the method comprises
detecting, with the processing component and on the captured image data, the shape of at least one surface, preferably a top surface, of the sample carrier (103) disposed on the placement area (102).

M3. The method according to any of the preceding method embodiments, wherein the method comprises determining with the processing component a sample carrier characteristic of the sample carrier (103).

M4. The method according to any of the preceding method embodiments, wherein the sample carrier (103) comprises a plurality of sample vial receptacles (107), wherein each sample vial receptacle (107) is configured to hold a sample vial (105).

M5. The method according to any of the preceding method embodiments with the features of embodiment M3, wherein the sample carrier characteristic is indicative of a shape of the sample carrier (103).

M6. The method according to any of the preceding method embodiments with the features of embodiment M3, wherein the sample carrier characteristic is indicative of a shape of a top surface of the sample carrier (103).

M7. The method according to any of the preceding method embodiments with the features of embodiment M3 and M4, wherein the sample carrier characteristic is indicative of a distribution of the sample vial receptacles (107).

M8. The method according to any of the preceding method embodiments with the features of embodiment M3 and M4, wherein the sample carrier characteristic is indicative of number of sample vial receptacles (107).

M9. The method according to any of the preceding method embodiments with the features of embodiment M4, wherein the sample vial receptacles (107) are evenly distributed on a top surface of the sample carrier (103).

M10. The method according to any of the preceding method embodiments, wherein the method comprises moving the platform component (101) relative to the imaging component (104) according to a motion.

M11. The method according to any of the preceding method embodiments, wherein said motion is rotation of the platform component (101) relative to the imaging component (104) around a rotation axis (106) parallel to a surface normal of the placement area (102).

M12. The method according to any of the 2 preceding embodiments, wherein the method comprises capturing with the imaging component (104) images during motion of the platform component (101).

M13. The method according to any of the preceding method embodiments, wherein the imaging component (104) is disposed at a predetermined height above the platform component (101).

M14. The method according to the preceding embodiment, wherein the predetermined height is at most 700 mm, preferably at most 600 mm, more preferably at most 550 mm from the top surface (102) of the platform component.

M15. The method according to any of the preceding method embodiments, wherein the imaging component (104) is disposed spaced apart from a central axis, preferably a rotation axis (106), of the platform component (101).

M16. The method according to any of the preceding method embodiments with the features of embodiment M11, wherein the imaging component (104) is disposed within a radial interval defined by
the rotation axis (106) of the platform component (101) and an outer most rotating point of the placement area (102),
preferably by an inwardly facing end (109) of the sample carrier (103) and an outwardly facing end (110) of the sample carrier (103),
more preferably defined by an inwardly facing end (109) of the sample carrier (103) and a vertical central axis of the sample carrier (103).

M17. The method according to any of the preceding method embodiments with the features of embodiment M4 and M11, wherein a radial position of the imaging component (104) with respect to the rotation axis (106) of the placement area (102) coincides with a radial position of at least one radially inner most sample vial receptacle (107) of the plurality of sample vial receptacles (107) with respect to the rotational axis (106).

M18. The method according to any of the preceding method embodiments and with the features of embodiment M15, wherein a radial distance (108) between the imaging component (104) and an inwardly facing end (109) of the sample carrier (103) is less than half of a distance between the inwardly facing end (109) and an outwardly facing end (110) of the sample carrier (103).

That is, the imaging component can be provided above an inner half of the sample carrier (103).

M19. The method according to any of the preceding method embodiments with the features of embodiment M15, wherein a radial distance (108) between the imaging component (104) and an inwardly facing end (109) of the sample carrier (103) is measured perpendicularly to the rotation axis (106).

M20. The method according to any of the preceding method embodiments with the features of embodiment M4, wherein the imaging component (104) is disposed such that it comprises a substantially uniform perspective on at least some of the plurality of sample vial receptacles (107) and/or on at least some of the sample vials (105) disposed within the sample vial receptacles (107).

M21. The method according to any of the preceding method embodiments, wherein an imaging plane of the imaging component (104) is parallel to the placement area (102).

M22. The method according to any of the preceding method embodiments and without the features of the preceding embodiment, wherein an imaging plane of the imaging component (104) is angled with respect to the placement area (102).

M23. The method according to any of the preceding method embodiments, wherein the method comprises correcting, with the processing component, optical distortions of the image data.

M24. The method according to the preceding embodiment, wherein correcting optical distortions of the image data comprises using intrinsic camera parameters of the imaging component (104).

M25. The method according to the preceding embodiment, wherein the method comprises executing with the processing component a camera calibration algorithm to determine the intrinsic camera parameters of the imaging component (104).

M26. The method according to any of the 3 preceding embodiments, wherein correcting the optical distortions of the image data comprises performing perspective correction based on the angle of the imaging plane relative to the top surface of the sample carrier (103).

M27. The method according to any of the 4 preceding embodiments, wherein correcting optical distortions of the image data comprises performing distortion correction based on the optical properties of the imaging component (104).

M28. The method according to any of the preceding method embodiments, wherein processing the image data comprises generating a top view representation of the sample carrier (103).

M29. The method according to the preceding embodiment and with the features of embodiment M23, wherein the correcting of the optical distortions of the image data is performed prior to generating the top view representation of the sample carrier (103).

M30. The method according to any of the 2 preceding embodiments, wherein the method comprises the processing component separating the sample carrier (103) from the placement area (102) and/or from background to generate the top view representation of the sample carrier (103).

Generally, it will be understood that in embodiments of the present invention, the processing component may also comprise a displaying component, e.g., a monitor, and the processing component may thus also be configured to display information to a user, e.g., the top view representation and/or the vial receptacle image, which will be referred to below.

M31. The method according to any of the preceding method embodiments, wherein capturing the image data comprises capturing an image sequence comprising a plurality of images, and wherein each image of the image sequence depicts a section of the placement area (102).

M32. The method according to the preceding embodiment and with the features of embodiment M10, wherein the method comprises capturing the image sequence during motion of the platform component (101).

M33. The method according to any of the 2 preceding embodiments, wherein each image of the image sequence depicts a different section of the placement area (102).

M34. The method according to any of the 3 preceding embodiments, wherein for at least two of the images of the image sequence, the respective sections of the platform component (101) depicted thereon partially overlap.

M35. The method according to any of the 4 preceding embodiments, wherein each section of the placement area (102) is at least represented once within the image sequence.

M36. The method according to any of the 5 preceding embodiments, wherein the method comprises extracting with the processing component image sections from the image sequence, preferably extracting with the processing component an image section from each of at least some images of the image sequence.

M37. The method according to the preceding embodiment, wherein at least some of the image sections, preferably each image section, is a circular sector.

M38. The method according to the preceding embodiment and with the features of embodiment M11, wherein each circular sector has the rotation axis (106) at its circle center.

M39. The method according to any of the 2 preceding embodiments, wherein each circular sector has an angle smaller than 10°, preferably smaller than 8°, further preferably smaller than 5°.

M40. The method according to any of the 4 preceding embodiments, wherein the method comprises extracting with the processing component the image sections in relation to a central point or the central axis of the placement area (102), preferably a rotation axis (106), of the platform component (101).

M41. The method according to any of the 5 preceding embodiments, wherein at least some of the image sections are rectangular, preferably strip-shaped.

M42. The method according to any of the 6 preceding embodiments, wherein each image section is radially aligned with a central axis, preferably a rotation axis (106), of the platform component (101).

M43. The method according to any of the 7 preceding embodiments, wherein each of the image sections depicts equally sized subsections of the placement area (102).

M44. The method according to any of the 8 preceding embodiments, wherein the image sections are of equal size.

M45. The method according to any of the 9 preceding embodiments, wherein the method comprises combining, with the processing component, the image sections and based thereon generating an overview image.

M46. The method according to the preceding embodiment, wherein the overview image comprises a cohesive image of all sample carriers (103) disposed on the placement area (103).

M47. The method according to any of 2 preceding embodiments, wherein the overview image comprises a cohesive image of the complete placement area (102) and of all sample carriers (103) disposed on the placement area (102).

For example, the overview image may comprise a photographic representation of the placement area comprising sampler carriers.

M48. The method according to any of the 3 preceding embodiments and with the features of embodiment M23, wherein correcting of the optical distortions of the image data is performed prior to generating the overview image.

M49. The method according to any of the 4 preceding embodiments, wherein the overview image is a two-dimensional top view.

M50. The method according to any of the preceding method embodiments, wherein the platform component (101) comprises at least one platform tracking indicator, and wherein the method comprises indicating, with the platform tracking indicator, a position and/or an orientation of the platform component (101) with respect to the field of view (114) of the imaging component (104).

M51. The method according to any of the preceding method embodiments, wherein the placement area (102) comprises at least one placement tracking indicator, and wherein the method comprises indicating, with the placement tracking indicator, a position and/or an orientation of the placement area (102) with respect to the field of view (114) of the imaging component (104).

M52. The method according to any of the preceding method embodiments, wherein the sample carrier (103) comprises at least one carrier tracking indicator, and wherein the method comprises indicating, with the carrier tracking indicator, a position and/or an orientation of the sample carrier (103) with respect to the field of view (114) of the imaging component (104).

M53. The method according to any of the preceding method embodiments, wherein the method comprises indicating, with an indicator component, a position indicator signal to the processing component and/or to the imaging component (104), said position indicator signal indicating the relative position of the platform component (101) and/or of the placement area (102) to the imaging component (104).

M54. The method according to the preceding embodiment, wherein the indicator component comprises at least one visual indicator which is disposed within the field of view (114) of the imaging component (104); wherein, e.g., the orientation of the at least one visual indicator corresponds to an orientation of the platform component (101) and/or the placement area (102).

M55. The method according to any of the preceding method embodiments and with the features of embodiment M36 and of any one of M50 to M54, wherein the method comprises aligning, with the processing component, the image sections according to the platform tracking indicator, placement tracking indicator, carrier tracking indicator and/or position indicator.

M56. The method according to any of the preceding method embodiments, wherein the method comprises moving, with a motion component, the platform component (101).

M57. The method according to the preceding embodiment, wherein the method comprises moving, preferably rotating, with the motion component, the platform component (101) in relation to the imaging component (104) to modify a section of the placement area (102) in the field of view (114) of the imaging component (104).

M58. The method according to the preceding embodiment, wherein the method comprises moving, with the motion component, the platform component (101) step-wise and wherein with each step, the placement area section within the field of view (114) of the imaging component (104) is modified, preferably moved by a predetermined distance along a predetermined trajectory, preferably a circular trajectory.

M59. The method according to any of the 3 preceding embodiments and with the features of embodiment M11, wherein the method comprises rotating, with the motion component, the platform component (101) around the rotation axis (106).

M60. The method according to any of the 4 preceding embodiments, wherein the method comprises performing, with the motion component, a step-wise movement sequence of the platform component (101) comprising a sequence of predetermined, preferably alternating, movement intervals and stop intervals.

M61. The method according to the preceding embodiment and with the features of embodiment M31, wherein capturing the image sequence comprises capturing, with the imaging component (104), an image during a stop interval, preferably an image during each stop interval and wherein the images captured during the stop intervals form the image sequence.

M62. The method according to any of the 2 preceding embodiments, wherein the method comprises synchronizing, with the processing component, the motion component with respect to the imaging component (104) to acquire image data during stop intervals.

M63. The method according to any of the 3 preceding embodiments, wherein the method comprises adjusting, with the processing component, a duration of the stop interval according to an image capture time required by the imaging component to capture an image.

M64. The method according to any of the 4 preceding embodiments, wherein the method comprises adjusting, with the processing component, the duration of the stop interval according to an inertia component of the movement of the platform component (101).

M65. The method according to any of the preceding method embodiments with the features of embodiment M31, wherein the method comprises capturing, with the imaging component (104), the sample carrier (103) disposed on the placement area (102) with the image sequence, in particular capture the sample carrier (103) completely.

M66. The method according to any of the preceding method embodiments, wherein the method comprises capturing, with the imaging component (104), the sample carrier (103) with a height of up to a predetermined maximum height.

M67. The method according to any of the preceding method embodiments and with the features of embodiment M4, wherein the method comprises determining, with the processing component, fill status characteristics, each indicative of the presence of a sample vial (105) in a corresponding sample vial receptacle (107).

M68. The method according to the preceding embodiment, wherein the method comprises determining, with the processing component, a respective fill status characteristic for each sample vial receptacle (107).

M69. The method according to any of the preceding method embodiments, wherein the method comprises determining, with the processing component, vial characteristics, each indicative of a property of a corresponding sample vial (105) disposed in the sample carrier (103).

M70. The method according to the preceding embodiment, wherein the method comprises determining, with the processing component, a respective vial characteristic for each sample vial (105) disposed in the sample carrier (103).

M71. The method according to any of the 2 preceding embodiments, wherein each vial characteristic is indicative of at least one of the following:
presence of a vial lid;
presence of a vial cap;
presence of a specific marking of the sample vial;
presence of a septum;
color of the vial;
color of the vial lid;
color of the sample comprised with the vial;
shape of the vial, in particular a cross-section and/or a shape of the vial opening;
volume of the vial;
length of the vial;
fill status of the vial with respect to a sample;
position of the sample vial within the sample vial receptacle;
orientation of the sample vial within the sample vial receptacle;
relative position of the sample vial with respect to the sample carrier (103);
relative position of the sample vial with respect to a spatial configuration of sample vial receptacles;
a marker of the sample vial, in particular a marker on a top side of the sample vial.

M72. The method according to any of the preceding method embodiments, wherein the method comprises generating, with the processing component, a carrier schematic comprising a schematic representation of the sample carrier (103).

M73. The method according to the preceding embodiment, wherein the carrier schematic comprises an outline of the sample carrier (103) and/or an outline of the sample vial receptacles (107) of embodiment M4.

M74. The method according to any of the 2 preceding embodiments, wherein the carrier schematic is indicative of the geometry of the sample carrier (103).

M75. The method according to any of the 3 preceding embodiments, wherein the method comprises generating, with the processing component, the carrier schematic by processing the image data.

M76. The method according to any of the 4 preceding embodiments and with the features of embodiment M28, wherein the method comprises generating, with the processing component, the carrier schematic by processing the top view representation of the sample carrier (103).

M77. The method according to any of the 5 preceding embodiments, wherein the method comprises generating, with the processing component, the carrier schematic based on a user input.

M78. The method according to any of the 6 preceding embodiments, wherein the method comprises generating, with the processing component, the carrier schematic by accessing a database of carrier schematics and selecting the carrier schematic in the database of carrier schematics.

M79. The method according to the preceding embodiment, wherein selecting the carrier schematic in the database of carrier schematics comprises using a carrier label, said carrier label preferably being indicative of a type or ID of the sample carrier (103).

M80. The method according to the preceding embodiment, wherein the method comprises detecting on the image data, with the processing component, the carrier label associated with the sample carrier (103).

M81. The method according to any of the preceding method embodiments with the features of embodiment M69 and M72, wherein the method comprises augmenting, with the processing component, the carrier schematic with at least one of the vial characteristics and generating based thereon an augmented carrier schematic.

M82. The method according to the preceding embodiment, wherein the method comprises augmenting, with the processing component, the carrier schematic with a vial characteristic for each detected sample vial.

M83. The method according to any of the 2 preceding embodiments, wherein the method comprises providing, with the processing component, the augmented carrier schematic as a basis for a sequence creation, such as a puncture sequence.

M84. The method according to any of the preceding method embodiments and with the features of embodiment M45 and M72, wherein the method comprises toggling, with the processing component, between providing the overview image and the carrier schematic, preferably the carrier schematic augmented with vial characteristics, to enable a comparison between generated schematics and the photographic representation of the placement area (102) comprising the sample carrier (103).

M85. The method according to any of the preceding method embodiments with the features of embodiment M72, wherein the method comprises generating, with the processing component, a schematic view depicting the carrier schematic.

M86. The method according to the preceding embodiment and with the features of embodiment M67, wherein the schematic view further depicts, preferably schematically, the fill status characteristics associated with each corresponding sample vial receptacle (107).

M87. The method according to any of the 2 preceding embodiments and with the features of embodiment M69, wherein the schematic view further depicts, preferably schematically, the vial characteristics associated with each corresponding sample vial (105) disposed in the sample carrier (103).

M88. The method according to any of the 3 preceding embodiments, wherein the method comprises displaying the schematic view on a display device that is operatively connected to the processing component.

M89. The method according to the preceding embodiment, wherein the method comprises displaying, preferably simultaneously, on the display device the schematic view and a sequence list input interface, wherein the sequence list input interface allows a user to input a sequence list indicative of an ordered list of sample vials (105) of the plurality of sample vials (105) disposed in the sample carrier (103).

For example, the system may be part of a chromatography system, e.g., a liquid chromatography system. That is, the liquid chromatography system may comprise the system described. In such a liquid chromatography system, runs may be performed with different samples, i.e., with different sample vials. For example, a first sample vial may be used for a first sample run, a second sample vial may be used for a second sample run, etc. Thus, different samples may be analyzed in sequence, and a list of this sequence may be referred to as a sequence list.

M90. The method according to the preceding embodiment, wherein the position within the ordered list determines the running order of the sequence.

M91. The method according to any of the preceding method embodiments and with the features of embodiment M4, wherein the method comprises generating, with the processing component, vial receptacle images, each depicting a top view of a respective sample vial receptacle (107).

M92. The method according to the preceding embodiment and with the features of embodiment M67 and/or M69, wherein the method comprises processing, with the processing component, the vial receptacle images to enhance the visual depiction thereon of the fill status characteristics and/or of the vial characteristics.

M93. The method according to any of the 2 preceding embodiments, wherein the method comprises cutting, with the processing component, the vial receptacle images from the image data and/or from the image sections of embodiment M36 and/or from the overview image of embodiment M45, preferably using a mask, more preferably a positive mask, even more preferably a positive mask with a circular shape.

M94. The method according to any of the 3 preceding embodiments and with the features of embodiment M88, wherein the method comprises displaying on the display device, preferably upon being prompted by a user, the vial receptacle images.

M95. The method according to the preceding embodiment, wherein the method comprises selectively displaying the vial receptacle images one at a time depending on a prompt provided by a user.

M96. The method according to any of the 2 preceding embodiments and with the features of embodiment M72, wherein the method comprises displaying each vial receptacle image overlayed on the carrier schematic, preferably overlayed over the corresponding sample vial receptacle (107).

M97. The method according to any of the 6 preceding embodiments and with the features of embodiment M72, wherein the method comprises incorporating, with the processing component, at least one of the vial receptacle images into the carrier schematic.

M98. The method according to any of the 7 preceding embodiments with the features of embodiment M72, wherein the method comprises incorporating, with the processing component, a plurality of the vial receptacle images into the carrier schematic, wherein each vial receptacle image relates to a separate sample vial receptacle (107).

M99. The method according to any of the preceding method embodiments with the features of embodiment M42 and M72, wherein the method comprises generating, with the processing component, a fill level schematic comprising a schematic representation of the fill status characteristics and incorporating, with the processing component, the fill schematic into the carrier schematic.

M100. The method according to any of the preceding method embodiments and with the features of embodiment M72, wherein the method comprises determining, with the processing component, a confidence threshold of the carrier schematic representing the actual status of the sample carrier (103) and providing, with the processing component, the image data and/or the top view representation of embodiment M28 to a user interface when the confidence threshold falls below a predetermined lower confidence threshold value.

M101. The method according to any of the preceding method embodiments with the features of embodiment M72, wherein the method comprises overlaying, with the processing component, the carrier schematic with the vial receptacle images of embodiment M91 and/or with the top view representation of the sample carrier (103) of embodiment M28.

M102. The method according to any of the preceding method embodiments and with the features of embodiment M45 and M88, wherein the method comprises displaying the overview image on the display device.

M103. The method according to any of the preceding method embodiments with the features of embodiment M28, wherein the method comprises overlaying, with the processing component, the top view representation of the sample carrier (103) with the carrier schematic of embodiment M72 and/or the vial receptacle images of embodiment M91.

M104. The method according to any of the preceding method embodiments and with the features of embodiment M72, wherein the method comprises generating, with the processing component, a carrier schematic for each sample carrier (103) present on the placement area (102).

M105. The method according to the preceding embodiment and with the features of embodiment M28, wherein the method comprises overlaying, with the processing component, for each sample carrier (103) present on the placement area (102), the respective carrier schematic with a respective top view representation of the sample carrier (103).

M106. The method according to any of the 2 preceding embodiments and with the features of embodiment M45, wherein the method comprises providing, with the processing component, a combined image comprising the overview image and the carrier schematics, preferably by either juxtaposing the overview image with the carrier schematics or by combining and aligning the overview image and the carrier schematics, more preferably the latter.

M107. The method according to any of the preceding method embodiments with the features of embodiment M69, wherein the method comprises mapping, with the processing component, a vial geometric shape, preferably a vial geometric shape of a plurality of vial geometric shapes, to a sample vial (105) based on the vial characteristic.

M108. The method according to the preceding embodiment, wherein the method comprises performing, with the processing component, at least one of the following image analyses to determine the vial characteristic:
a brightness contrast detection,
a color contrast detection;
an edge detection on the image data on the image data,
sharpening, and/or
smoothing or blurring.

M109. The method according to any of the 2 preceding embodiments, wherein the method comprises, executing, with the processing component, a neural network and wherein the neural network is trained based on a learning sequence comprising platform component data, placement area data and/or sample carrier data.

M110. The method according to the preceding embodiment, wherein the neural network is trained to determine a sample carrier characteristic and/or a vial characteristic.

M111. The method according to any of the 2 preceding embodiments, wherein the platform component data relates to geometric properties of the platform component (101), preferably in the form of an image representation of a platform component (101), more preferably in the form of a plurality of platform component images comprising different platform component geometries.

M112. The method according to any of the 3 preceding embodiments, wherein the placement area data relates to geometric properties of the placement area (102), preferably in the form of an image representation of the placement area (102), more preferably in the form of a plurality of overview images comprising different placement area geometries.

M113. The method according to any of the 4 preceding embodiments, wherein the sample carrier data relates to geometric properties of the sample carrier (103), preferably in the form of an image representation of the sample carrier (103), more preferably in the form of a plurality of sample carrier images comprising different sample carrier geometries.

M114. The method according to any of the preceding method embodiments, wherein the image data comprises a side angle view, such as an oblique view, of the sample carrier (103) and wherein the method comprises extracting, with the processing component, a code, preferably a graphical code, from the image data.

M115. The method according to any of the preceding method embodiments, wherein the placement area (102) and/or the sample carrier (103) comprises a code.

M116. The method according to any of the preceding method embodiments, wherein the image data comprises a substantially distorted representation of the sample carrier (103).

M117. The method according to any of the preceding method embodiments with the features of embodiment M72, wherein the method comprises overlaying, with the processing component, parts of the carrier schematic over the top view representation of embodiment M28 and/or the overview image of embodiment M45, and providing based thereon an augmented reality representation of the sample carrier (103).

M118. The method according to any of the preceding method embodiments with the features of embodiment M28 and/or M45, wherein the method comprises replacing, with the processing component, sections of the top view representation and/or the overview image with the carrier schematic or at least a segment of the carrier schematic of embodiment M72.

M119. The method according to any of the preceding method embodiments with the features of embodiment M4, wherein the method comprises displaying, with the processing component, for at least one sample vial (105) in the top view representation of embodiment M28 and/or in the overview image of embodiment M45 and/or in the carrier schematic of embodiment M72: a sample name, information relating to a processing method corresponding to the sample vial, and/or a position of the sample vial.

M120. The method according to any of the preceding method embodiments, wherein the method comprises receiving, with the processing component, information relating to a geometry of the sample carrier (103) by a user input.

M121. The method according to any of the preceding method embodiments, wherein the method comprises determining, with the processing component, information relating to a geometry of the sample carrier (103) by reading information, e.g., a barcode on the sample carrier (103).

M122. The method according to any of the preceding method embodiments, wherein the method comprises determining, with the processing component, a sample carrier type corresponding to the sample carrier (103).

M123. The method according to the preceding embodiment, wherein determining the sample carrier type is based on a user input, preferably on a user selection of a sample carrier type out of a plurality of reference sample carrier types.

M124. The method according to any of the 2 preceding embodiments, wherein determining the sample carrier type is based on a geometrical feature of the sample carrier (103).

M125. The method according to the preceding embodiment, wherein the method comprises determining, with the processing component, the sample carrier type by comparing the geometrical feature of the sample carrier (103) with reference geometrical features corresponding to reference sample carrier types.

M126. The method according to the preceding embodiment, wherein the reference sample carrier types are stored associated with respective reference geometrical features in a reference database and wherein the method comprises accessing, with the processing component, the reference database.

M127. The method according to any of the 2 preceding embodiments, wherein the method comprises generating, with the processing component, a new reference sample carrier type and to associate the new reference sample carrier type with the geometrical feature of the sample carrier (103), if no matching is found between the geometrical feature of the sample carrier (103) and the reference geometrical features.

M128. The method according to the 2 preceding embodiments, wherein the method comprises adding, with the processing component, the new reference sample carrier type associated with the geometrical feature of the sample carrier (103) to the reference database.

M129. The method according to any of the 5 preceding embodiments, wherein the method comprises determining, with the processing component, the geometrical feature of the sample carrier (103) by processing the image data, preferably a portion of the image data corresponding to the sample carrier (103), such as, the top view representation of embodiment M28.

M130. The method according to any of the 6 preceding embodiments and with the features of embodiment M45, wherein the method comprises determining, with the processing component, the geometrical feature of the sample carrier (103) by processing the overview image, preferably a portion of the overview image corresponding to the sample carrier (103).

M131. The method according to any of the 7 preceding embodiments, wherein the method comprises determining, with the processing component, the geometrical feature of the sample carrier (103) by processing an image of the sample carrier (103), said image captured while the sample carrier (103) is empty and wherein the image data comprise said image.

M132. The method according to any of the 8 preceding embodiments, wherein the geometrical feature comprises an outline of the sample carrier (103).

M133. The method according to any of the 9 preceding embodiments and with the features of embodiment M4, wherein the geometric feature comprises a vial positional pattern of the sample vial receptacle (107).

M134. The method according to the preceding embodiment, wherein the vial positional pattern is a 2-dimensional pattern.

M135. The method according to any of the 2 preceding embodiments, wherein the method comprises determining, with the processing component, the vial positional pattern by determining respective positions, preferably midpoint positions, of at least some of the sample vial receptacle (107) and fitting a pattern to the determined positions.

M136. The method according to the preceding embodiment, wherein fitting the pattern to the determined positions comprises using algebraic and/or regression analysis.

M137. The method according to any of the 2 preceding embodiments, wherein fitting the pattern to the determined positions comprises determining a best-fit pattern from a library of reference patterns.

M138. The method according to any of the 5 preceding embodiments, wherein the method comprises storing, with the processing component, the vial positional pattern as a new pattern in a library of reference patterns.

M139. The method according to any of the 2 preceding embodiments and with the features of embodiment M126, wherein the library of reference patterns is stored in the reference database.

M140. The method according to any of the 7 preceding embodiments, wherein the method comprises determining, with the processing component, a quality level for the vial positional pattern and automatically associating, with the processing component, the vial positional pattern with the sample carrier (103) if the quality level exceeds a quality threshold level.

M141. The method according to any of the 8 preceding embodiments, wherein the method comprises displaying, with the processing component, the vial positional pattern, preferably simultaneously with image data representing the sample carrier (103), and receiving, with the processing component, user input to confirm the vial positional pattern.

M142. The method according to any of the 9 preceding embodiments, wherein the method comprises determining, with the processing component, a puncture position for a probe needle based on vial positional pattern.

M143. The method according to any of the preceding method embodiments, wherein the sample carrier (103) is a well-plate.

M144. The method according to any of the preceding method embodiments, wherein the method comprises determining, with the processing component, a puncture of a vial, e.g., a sample vial, preferably a puncture of a vial seal, i.e., a septum, in particular a puncture by a probe needle.

M145. The method according to the preceding embodiment, wherein the method comprises adjusting, with the processing component, an image data parameter of the image data to determine a puncture and/or puncture position of the vial.

M146. The method according to the preceding embodiment, wherein the image data parameter is an exposure value, a contrast value, and/or an illumination parameter.

M147. The method according to any of the 2 preceding embodiments, wherein the method comprises determining the puncture and/or puncture position of the vial based on a contrast difference in the image data.

M148. The method according to any of the preceding method embodiments, wherein the method comprises determining, with the processing component, a position difference between an expected puncture position and a captured puncture position.

M149. The method according to the preceding embodiment, wherein the method comprises adjusting, with the processing component, a puncture position for a subsequent sample carrier and/or subsequent vial based on the position difference, in particular to reduce the position difference.

M150. The method according to the preceding embodiment, wherein the method comprises adjusting, with the processing component, the puncture position if and only if the position difference is smaller than a difference threshold.

M151. The method according to any of the 2 preceding embodiments, wherein the adjustment of the puncture position is smaller than the position difference, wherein the adjustment of the puncture difference is preferably smaller than 80% of the puncture difference, further preferably smaller than 60% of the puncture difference, such as smaller than 40% of the puncture difference.

M152. The method according to any of the preceding method embodiments with the features of embodiment M144, wherein the method comprises iteratively determining and/or correcting, with the processing component, the puncture position of a sequence of vials, in particular, adjusting, with the processing component, a puncture position of a subsequent vial based on a determined puncture position of a previous vial.

M153. The method according to any of the preceding method embodiments with the features of embodiment M148, wherein the method comprises determining, with the processing component, a plurality of position differences, preferably position differences for a complete sample carrier (103).

M154. The method according to the preceding embodiment, wherein the method comprises averaging, with the processing component, the plurality of position differences and to determine a puncture position correction for a sample carrier (103) based on the difference average.

M155. The method according to any of the 2 preceding embodiments, wherein the method comprises determining, with the processing component, a drift, in particular a systematic drift, of puncture positions based on the plurality of position differences.

M156. The method according to any of the preceding method embodiments with the features of embodiment M148, wherein the method comprises determining, with the processing component, a wear level based on the position difference.

M157. The method according to the preceding embodiment, wherein the method comprises providing, with the processing component, a warning and/or stopping, with the processing component, a subsequent puncture when the wear level exceeds a predetermined threshold value.

M158. The method according to any of the preceding method embodiments, wherein the method comprises extracting, with the processing component, position marker data from the image data, wherein the position marker data defines at least one puncture position, preferably in relation to the sample carrier (103), respectively the sample carrier position on the placement area (102).

M159. The method according to the preceding embodiment, wherein the method comprises setting, with the processing component, a plurality of puncture positions according to the position marker data.

M160. The method according to any of the preceding method embodiments, wherein the method comprises utilizing a calibration target.

M161. The method according to the preceding embodiment, wherein the method comprises disposing the calibration target on the placement area (102) or on the sample carrier (103).

M162. The method according to any of the 2 preceding embodiments, wherein the image data comprises at least two representations of the calibration target at different positions relative to the capture component.

M163. The method according to the preceding embodiment, wherein the method comprises determining, with the processing component, a distance and/or displacement vector between the two representations of the calibration target.

M164. The method according to any of the 4 preceding embodiments, wherein the calibration target comprises at least one uniquely identifiable marker.

M165. The method according to any of the 5 preceding embodiments, wherein the calibration target comprises at least two uniquely identifiable markers which are spaced apart relative to one another.

M166. The method according to any of the preceding method embodiments with the features of embodiment M162 and M164, wherein the two representations of the calibration target each comprise a representation of the at least one uniquely identifiable marker, and wherein the method comprises determining, with the processing component, a distance and/or displacement vector between the two representations of the uniquely identifiable marker, in particular for each uniquely identifiable marker comprised in the image data.

M167. The method according to any of the preceding method embodiments with the features of embodiment M163 or M166, wherein the method comprises calculating, with the processing component, a central perpendicular of the displacement vector, in particular calculating at least two central perpendiculars for two uniquely identifiable markers and their respective displaced representations.

M168. The method according to the preceding embodiment, wherein the method comprises determining, with the processing component, a central point, in particular a rotation axis (106), of the placement area (102) and/or the platform component (101) from the intersection of two central perpendiculars.

M169. The method according to any of the preceding embodiments, wherein the platform component is part of an autosampler for a chromatography system, preferably for a liquid chromatography system, more preferably for a high-performance liquid chromatography system.

M170. The method according to any of the preceding embodiments and with the features of embodiment M45 and M72, wherein the method comprises providing, with the processing component, a combined image comprising the overview image and the carrier schematic, preferably by either juxtaposing the overview image with the carrier schematic or by combining and aligning the overview image and the carrier schematics, more preferably the latter.

Below, system embodiments will be discussed. These embodiments are abbreviated by the letter “S” followed by a number. Whenever reference is herein made to “system embodiments”, these embodiments are meant.

S1. System (100) comprising
a platform component (101) having a placement area (102) configured to hold a sample carrier (103);
an imaging component (104) configured with a field of view (114) towards the placement area (102) and configured to capture image data of at least a part of the placement area (102);
a processing component configured to process the image data.

S2. The system according to the preceding embodiment, wherein the system is configured to carry out the method according to any of the preceding method embodiments.

Below, further embodiments will be discussed.

A1. An autosampler for a chromatography system, wherein the autosampler comprises the system according to any of the preceding system embodiments.

A2. A chromatography system comprising the autosampler of the preceding embodiment.

A3. Use of the system according to any of the preceding system embodiments, the autosampler according to embodiment A1 and/or the chromatography system according to embodiment A2 in liquid chromatography, preferably in high performance liquid chromatography.

Below, further method embodiments will be discussed.

M171. The method according to any of the preceding method embodiments, wherein the method comprises utilizing the system according to any of the preceding system embodiments, an/or the autosampler according to embodiment A1, and/or the chromatography system according to embodiment A2.

The present invention will now be described with reference to the accompanying drawings, which illustrate embodiments of the invention. These embodiments should only exemplify, but not limit, the present invention.

### BRIEF DESCRIPTION OF THE DRAWINGS

FIG. 1 schematically depicts a system for capturing image data of a platform component having a placement area configured to hold a sample carrier;

FIG. 2 depicts a flowchart of a method for capturing and processing image data of a platform component having a placement area configured to hold a sample carrier;

FIG. 3 depicts a flowchart of a method for determining a sample carrier type;

FIG. 4 depicts an overview image generated by the image data;

FIG. 5A depicts an image of the platform component having a calibration pattern disposed thereon at a first pose of the platform component;

FIG. 5B depicts a second image of the platform component having the calibration pattern disposed thereon at a second pose of the platform component; and

FIG. 6 depicts a flowchart of a method for adjusting a puncture position;

FIG. 7 depicts a processing component.

### DETAILED DESCRIPTION OF THE DRAWINGS

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

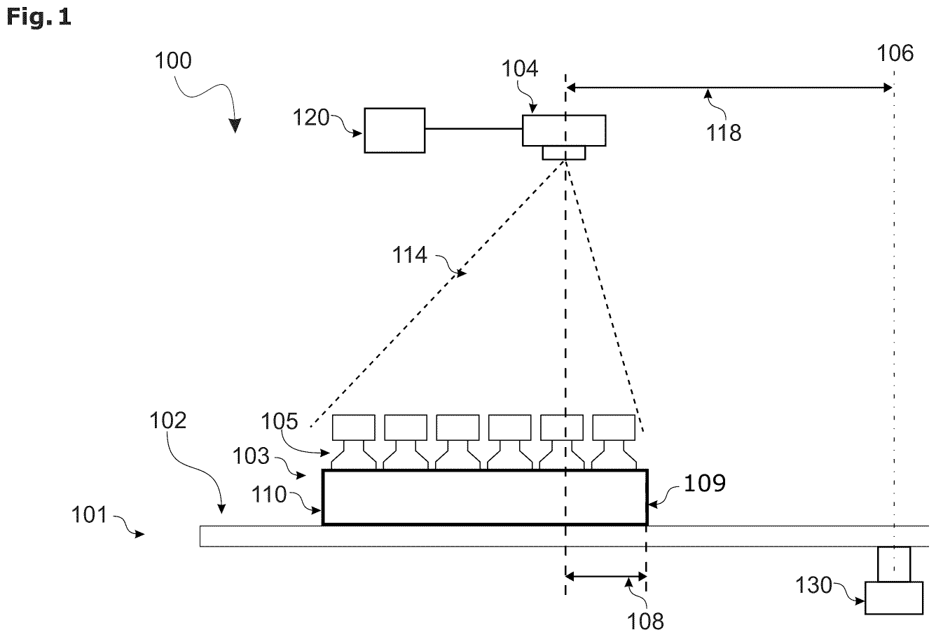

FIG. 1 is a schematic side view of a system 100. The system 100 may be part of an autosampler, said autosampler preferably being configured to draw samples from sample vials and introduce the samples in an analytical flow. Further preferably, the autosampler may be part of a chromatography system such as, high-performance liquid chromatography (HPLC) system.

The system 100 comprises a platform component 101. The platform component 101 can be configured to move, preferably rotate around a rotation axis 106. Thus, the platform component 101 may also be referred to, interchangeably, as a turntable 101. The rotation axis 106 may be a vertical central axis 106 of the platform component 101. Thus, FIG. 1 may depict only a portion of the platform component 101, which lies on a side of the rotation axis 106, and the platform component 101 may further extend on the other side of the rotation axis 106.

The platform component 101 may comprise a placement area 102, which may be a top surface, or a portion thereof, of the platform component 101. The placement area 102 may preferably extend perpendicularly to the rotation axis 106. That is, the rotation axis 106 may be parallel with a normal of the placement area 102. In particular, the placement area 102 may extend horizontally while the rotation axis 106 may be vertical. The vertical direction is parallel to a direction of gravity when the system 101 is in use.

The placement area 102 and the platform component 101 can be configured to hold one or more sample carriers 103. For sake of simplicity, FIG. 1 shows a single sample carrier 103. The sample carrier 103 can be positioned on the placement area 102 such that it can comprise an inwardly facing end 109 and an outwardly facing end 110. The inwardly and outwardly facing ends 109, 110 can be opposite to each other. The inwardly facing end 109 may refer to an end of the sample carrier 103 that is closest to a vertical central axis of the platform component 101. The outwardly facing end 109 may refer to an end of the sample carrier 103 that is furthest from a vertical central axis of the platform component 101. Thus, a line connecting the inwardly and outwardly facing ends 109, 110 can lie along a radius of the platform component 101. In other words, the sample carrier 103 may extend from the inwardly to the outwardly facing end 109, 110 radially.

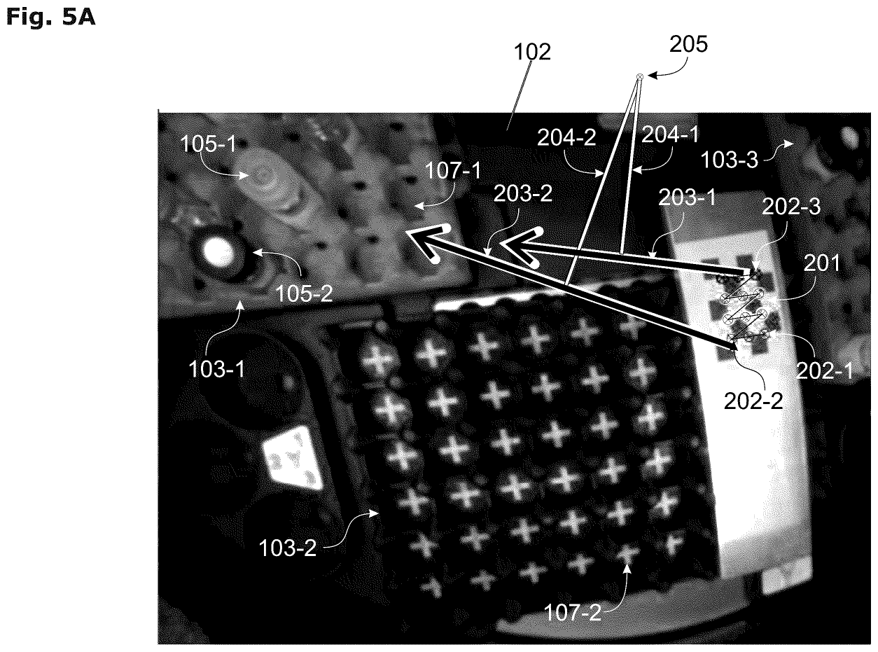

The sample carrier 103 can be configured to carry one or more sample vials 105. In particular, the sample carrier 103 can comprise one or more sample vial receptacles 107 (see FIG. 4), each configured to receive a sample vial 105. Each sample vial 105 can be filled with a sample.

The system 100 further comprises an imaging component 104. The imaging component 104 is arranged such that it comprises a field of view 114 towards the placement area 102. In FIG. 1 the field of view 114 of the imaging component is schematically represented via the broken lines radiating from the imaging component 104.

The imaging component 104 may thus capture image data of the placement area 102 and of the sample carrier(s) 103 placed thereon. Preferably, the imaging component 104 may capture image data of all sample carriers 103 placed thereon. However, as depicted, the imaging component 104 may comprise a limited field of view 114 that may not cover the entire placement area 102 and consequently not all the sample carriers 103 placed thereon.

The platform component 101 may be configured to rotate around the rotation axis 106 and with respect to the imaging component 104. For example, the system may comprise a motion component 130 configured to move the platform component 101 around the rotation axis 106. This way, a portion of the placement area 102 within the field of view 114 of the imaging component 104 can change. Additionally, the system 100 may be configured to synchronize the capturing of the image data by the imaging component 104 with rotation of the platform component 101. This way, the entire, or at least a larger, portion of the placement area 102 can be captured by the imaging component 104.

Typically, the vertical spacing of system 100, i.e., the space above the placement area 102, may be limited. In other words, a vertical position of the imaging component 104 may be in close vertical proximity to the placement area 102. This, on the one hand, may limit a portion of the placement area 102 covered by the field of view 114. On the other hand, the small vertical distance between the imaging component 104 and the placement area 102, may cause the captured image data of the placement area 102 to be optically distorted. Optical distortions can include “fish eye”-distortions and/or pincushion effects.

The field of view 114 of the imaging component may be increased using suitable optical components, e.g., using a fish-eye lens, however, this may increase optical distortions and may case the image data to appear unnatural. For example, directly below the imaging component 104, sample vials 105 may appear normally as captured from above, while at the edge of the field of view 114, the sample vials 105 may be captured from the side.

To mitigate these issues, the imaging component 104 can comprise a horizontal position that is distanced from a vertical central axis of the platform component 101. That is, the imaging component 104 can be positioned off-center with respect to the platform component. The imaging component 104 may be aligned with sample vials 105 closest to the center of the platform component 104. For example, as depicted in FIG. 1, the imaging component 104 is disposed approximately above the second most inward sample vial 105. In particular, the imaging component 104 may be positioned at a distance 108 away from the inwardly facing end 109 of the sample carrier 103.

The imaging component 104 may be positioned at a distance 118 away from the rotation axis 106.

Said distances 108, 118 may be radial distances 108, 118, i.e., measured radially with respect to the rotation axis 106. In particular, said distances 108, 118 may be measured from an optical axis of the imaging component 104.

Placing the imaging component 104 off-center as discussed can allow the capturing of better images of the sample carrier 103 with a more uniform and consistent perspective of the sample vials 105. Placing the camera further outward, i.e., further away from the vertical central axis of the platform component 101, would cause the inner sample vials 105 to tilt inward (i.e., towards the rotation axis 106) and the outer sample vials 105 to tilt outward (i.e., away from the rotation axis 106) when viewed in images captured by the imaging component 104, resulting in an image with less uniform perspectives of the sample vials 105. On the other hand, placing the imaging component 104 further inwards with respect to the rotation axis 106 may enhance the effect of the side view of the outer sample vials 105 and may also require a larger field of view 114 for the imaging component 104 to be able to capture an entire radial extension of the sample carrier 103.

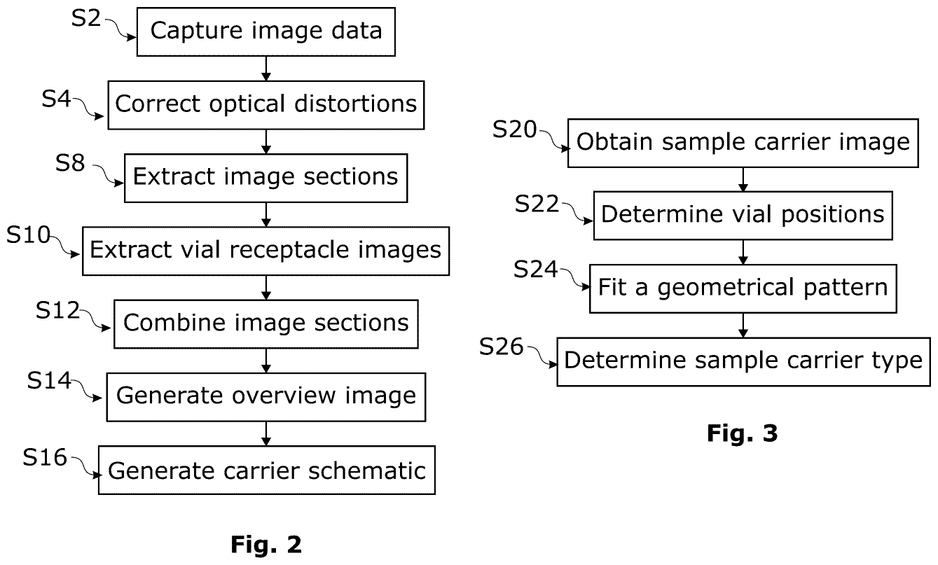

FIG. 2 depicts a flowchart of a method that can be carried out by the system of FIG. 1. In the following description of FIG. 2, reference to components of the system of FIG. 1 is made.

In S2, the method comprises capturing image data. For example, the image data can be captured with the imaging component 104. Preferably, capturing image data can comprise capturing an image sequence, wherein each image in the image sequence corresponds to a different relative pose between the placement area 102 and the imaging component 104.

S2 can preferably comprise rotating the platform component 101 and capturing images. These two steps can be performed iteratively until the entire placement area 102 (or at least all portions of the sample carriers 103) can be imaged. Thus, the image data can comprise images of the entire placement area 102 (or at least all portions of the sample carriers 103). That is, the placement area can be rotated by 360° and meanwhile images can be captured.

In S3, the method can comprise correcting optical distortions of the image data. S3 can preferably be performed by a processing component 120 (see FIG. 1). Correcting optical distortions can be performed based on the intrinsic camera parameters of the imaging component 104. S3 may also be based on a calibration of the camera position to the turntable discussed further below in more detail. Correcting the optical distortions can allow the image data to more accurately represent the placement area 102 and/or the sample carrier 103.

In S4, the method can comprise extracting image sections from the image data. S4 can be performed by the processing component 120. An image section can be extracted from each image captured in S2. The image sections can be longitudinal in a radial direction with respect to a central axis of the platform component 101, such as, the rotation axis 106. The image sections can be narrow in an orthogonal direction to the radial direction. That is, the image sections can be narrow and long, with the length dimension extending generally parallel with the radial direction.

The image sections can be circular sectors. Each circular sector may be radially aligned with respect to the rotation axis 106. For example, each circular sector may comprise the rotation axis 106 at its circle center. Furthermore, the circular sectors can preferably comprise a small angle. Thus, the circular sectors can be narrow and long. This can ensure that the vials can be consistently imaged at similar angles, preferably directly from above. That is, if the image sections are selected to be wide (instead of narrow), e.g., with a large angle, the imaging sections would include lateral views from a first side of the sample vial and as the platform component rotates, direct views from above, and then lateral views from a second side of the sample vial. The narrower the image sections, e.g., the smaller the angle of the circular sectors, the more constant the viewing angle, as lateral views are cut off. This increases the optical quality of the image sections.

In S10, the method may further comprise extracting vial receptacle images. Herein the method can preferably comprise extracting a respective vial receptacle image for each vial receptacle of the sample carrier 103. Each vial receptacle image can depict a top view of a respective vial receptacle of the sample carrier 103. The vial receptacle images can be extracted directly from the image data, but it can be more preferable to extract the vial receptacle images from the image sections as this can increase the likelihood of the vial receptacle images depicting top views of the respective vial receptacles.

It will be understood that the vial receptacle images are different from the image sections discussed herein. Each vial receptacle image may depict a single vial receptacle, while the image sections may each depict multiple vial receptacles. Typically, image sections may each depicts a portion of the placement area 102 and of the sample carrier 103 extending radially with respect to the rotation axis 106 within the limits of the field of view 114.

It will be further understood that when a vial receptacle is occupied, the respective vial receptacle image naturally shows a top view of the sample vial in the vial receptacle image.

In S12, the method may comprise combining the image sections and in S14 generating based thereon an overview image. Preferably S12 and S14 may be performed by the processing component 120. S12 and S14 may comprise aligning the image sections. The alignment may utilize positional information indicative of the relative pose between the imaging component 101 and the placement area 102. S12 and S14 may comprise stitching the image sections to thereby generate the overview image.

As discussed, while each image of the image data captured in S2 only depicts a portion of the placement area 102 due to the limited field of view 114 of the imaging component 104, the image data may comprise images of a larger portion of and preferably of the entire placement area (or at least all portions of the sample carriers 103). By extracting and combining image sections at least two advantages may be achieved:

Firstly, the overview image can depict the entire placement area 102 and consequently all the sample carriers 103 that may be disposed thereon.

Secondly, the overview image can depict the placement area 102 with a more uniform viewing angle. In particular, the maximum viewing angle over the entire overview image is the same as the maximum viewing angle over a single image section. Simply put, the overview image depicts all the portions of the placement area 102 as viewed substantially directly from above.

An exemplary overview image is shown in FIG. 4. Said exemplary overview image is generated from image data of a placement area 102 that comprises four sample carriers 103-4 to 103-7.

In S16, the method can comprise generating a carrier schematic. The carrier schematic may also be interchangeably referred to as schematic image or schematic representation. It can depict a schematic representation of the sample carrier 103.

Preferably, the carrier schematic can depict a schematic representation of the entire placement area 102 and consequently of all sample carriers 103 placed thereon. The carrier schematic may thus depict an overview schematic of the placement area 102. This is different from the overview image which instead depicts a photographic representation of the placement area 102.

The carrier schematic may include outlines of the sampler carrier(s) 103 placed on the placement area 102. That is, the carrier schematic may provide an abstracted view of the sampler carrier's geometry. The sample holder geometry can be obtained directly from the overview image through image processing, selected or defined by the user, or obtained from another device information, such as a barcode on the sample carrier.

Using the sample holder geometry, a portion of the overview image depicting the sample holder or one or more image sections depicting the sample holder can be processed, preferably by the processing component, to extract further information that can be augmented to the schematic image.

That is, the carrier schematic may include further information related to the sample carrier 103. For example, the carrier schematic may be augmented with fill status characteristics, each indicative of the presence of a sample vial 105 in a corresponding sample vial receptacle 107. The fill status characteristics may be depicted schematically within the carrier schematic. Alternatively or additionally, the carrier schematic may be augmented with vial characteristics, each indicative of a property of a corresponding sample vial 105 disposed in the sample carrier 103. The vial characteristics may be depicted schematically within the carrier schematic.

Various methods and algorithms can be used and combined for obtaining the further information from processed images, such as:
Only round segments where each sample vial is expected to be located can be extracted from the image data, image sections and/or overview image using a positive mask to hide surrounding artifacts that would interfere with clear optical perception.
Image filtering can occur, resulting in a clear optical enhancement of the image through contrast and color enhancement, sharpening or smoothing, edge detection. Thereby, information, such as vial present, lid present, lid color, and septum, can be more clearly obtained.
Similarly, recognition of a specific feature, such as vial present, lid present, no vial present, or a specific marking on the vial or lid, can be achieved using a pre-trained computer-based neural network.
Furthermore, extraction of image information, such as lid color or septum diameter, can be determined through computer-based analysis.

The filtered images or symbols/labels for the information obtained from the processed images can then be added to the corresponding position of the geometry representation and displayed on a display device.

The overall image and the schematic image can be stored. They can be displayed on demand, e.g., by activating their display via a control element in a software, in particular a software for sequencing. For example, via a user interface, the overview image and the carrier schematic can be selectively hidden or shown at the same location. Different types of crossfades between the carrier schematic and the overview image can be possible. Different types of overlay between the carrier schematic and the overview image can also be possible. This can allow the user to compare the carrier schematic with the overview image.

The carrier schematic can be provided for a sequence creation. The augmented representation can replace a simpler turntable representation that does not comprise added information.

Steps S4 to S16 can be carried out by the processing component 120.

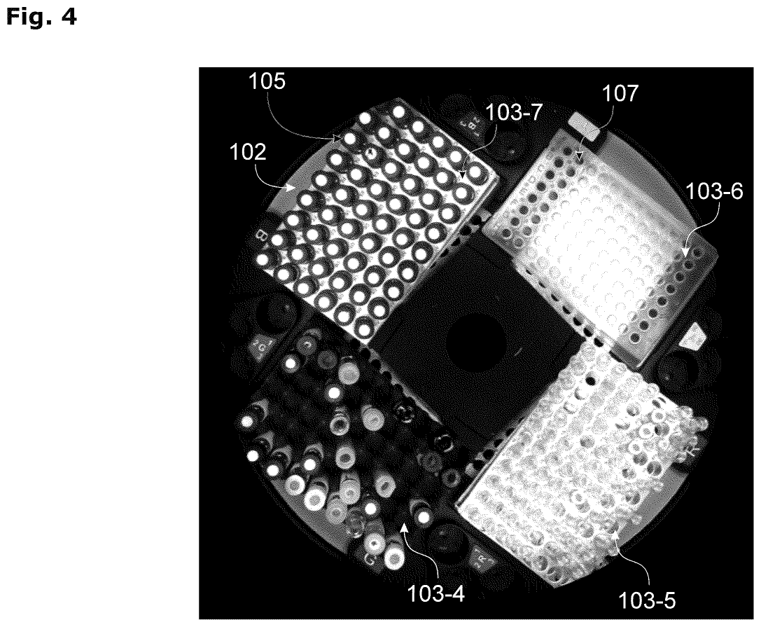

FIG. 3 depicts a method for automatically determining sample carrier type, such as, a sample carrier geometry.

In S20, an image of a sample carrier 103 (see FIG. 1) can be obtained. Preferably, the sample carrier can be empty, i.e., without sample vials being disposed in the sample carrier. The sample carrier image in S20 can be obtained for example during the capturing of the image data in S2 (see FIG. 2). Alternatively, the sample carrier image in S20 may be an image captured in S2 (see FIG. 2) that has further undergone optical distortion correction as in S4 (see FIG. 1). Alternatively, the sample carrier image in S20 may be extracted from the overview image generated in S14 (see FIG. 2).

For example, the sample carrier image in S20 may be obtained by cropping the portion of the overview image depicted in FIG. 4 that corresponds to the sample carrier 103-6 (which is empty). Said sample carrier image may allow determining the sample carrier type of the sample carrier 103-6.

In S22, vial positions can be determined by processing the sample carrier image. The vial positions can be respective positions, such as, respective center points of sample vial receptacles 107 of the sample carrier 103. For example, using image recognition, e.g., filtering, edge detection, circle fitting, center points of vial positions can be detected in the sample carrier image. While it may not be necessary to detect all sample vial position, it can be advantageous to detect as many vial positions as possible.

In S24, a geometric pattern can be fitted to the determined vial positions. Said geometrical pattern can be a 2-dimensional pattern. That is, an X-direction and/or a Y-direction of the vial positions can be determined. Preferably, the directions can be determined based on as many recognized, neighboring vial positions as possible. S24 might involve selecting a best-fit pattern from a library of reference patterns. This library may comprise predefined patterns representing various positional arrangements of the sample vial receptacles within a sample carrier. Alternatively, the geometric pattern can be fitted using algebraic and regression analysis.

After fitting the pattern, S24 may assess the quality of the fit. This quality control step ensures that the fitted pattern accurately represents the spatial arrangement of sample vial receptacles in the sample carrier.

In some cases, the fitted vial positional pattern may be displayed to the user simultaneously with the image data representing the sample carrier. The user might be prompted to confirm the accuracy of the fitted pattern through manual input. For example, the determined pattern can be overlayed over the image of the sample carrier. This combined image of the sample carrier with a superimposition of the determined pattern can be displayed to the user to decide whether it is the correct pattern or whether the pattern is sufficiently similar to the original shape of the sample carrier.

If the vial positional pattern is new or significantly deviates from existing reference patterns, it might be stored as a new pattern in a library of reference patterns for future use.

The pattern can also be used without the interaction of the user, whereby a quality value of the pattern recognition can be used so that the computer can decide whether the pattern has been sufficiently recognized.

FIG. 4 shows an exemplary overview image constructed from a plurality of captured and processed images. In this example, four sample carriers 103-4 to 103-7 are disposed on the placement area 102. As depicted, the overview image depicts a top view photographic representation of all the sample carriers 103-4 to 103-7 disposed on the placement area 102.

Thus, the present invention may generate a top view photographic representation of an entire placement area 102 even though the field of view 114 of the imaging component 104 (see FIG. 1) may not cover the entire placement area 102. Additionally, the overview image can be generated such that optical distortions are mitigated. As can be noticed from the exemplary overview image in FIG. 4, throughout the overview image, the viewing angle is substantially the same. Further still, all sample vials 105 and sample vial receptacles 107 appear on the image as if they had been viewed from above. In contrast, it is noted herein, that the same would not be true if, e.g., the placement area 102 was captured entirely in a single image with an imaging component comprising a large field of view. In this example, particularly the corners of the image would appear with an outward tilt away from the image center.

An aspect of the present invention may be the calibration between the position of the imaging component and the position of the center of the platform component, wherein said center may be on the rotation axis 106 (see FIG. 1). This calibration can facilitate the method according to FIG. 2, and in particular, correcting optical distortions of the image data in S4 and/or combining the image sections in S12.

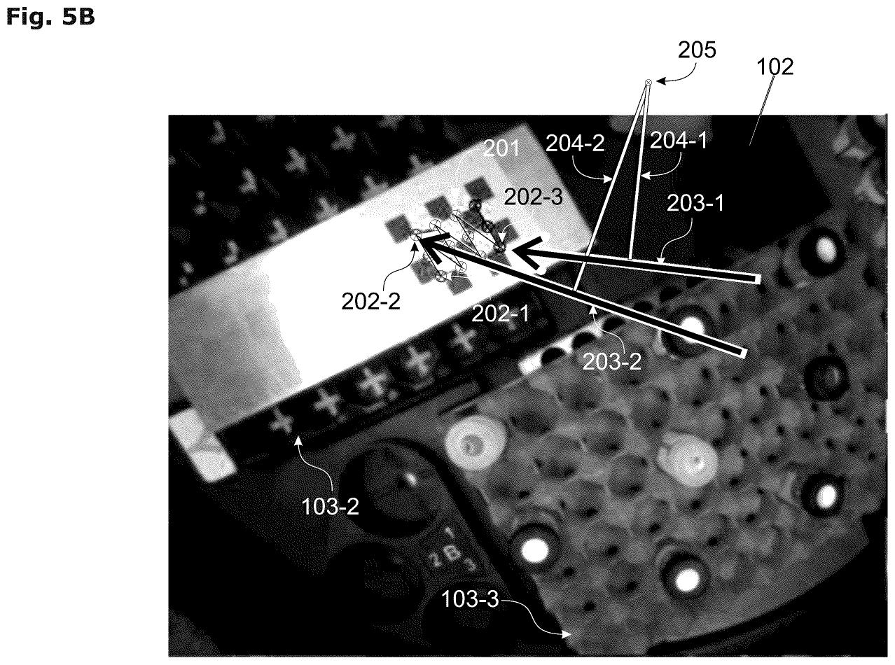

FIG. 5A shows a photographic representation of a section of the placement area 102 comprising at least part of three sample carriers 103-1, 103-2, 103-3. The position of the camera relative to the center of the placement area 102 can be determined using a calibration pattern 201, e.g., a checker board 201, which can be disposed on the placement area 102. Preferably, the calibration pattern 201 can be fixed to the placement area 102 such that it may not move relative to the placement area 102. The calibration pattern 201 can be fixed at least for the duration of the calibration process. The calibration pattern 201 can be captured by the imaging component 104 in at least two different poses of the placement area 102. That is, the calibration pattern 202 can be captured before and after a rotation of the placement area 102. FIG. 5B shows a photographic representation of the same placement area 102 as shown in FIG. 5A but the placement area 102 has been rotated.

In both images, uniquely identifiable markers 202 of the calibration pattern 201, e.g., corner points 202 of squares, can be detected and matched to each other. In particular, a first set of uniquely identifiable markers 202 can be detected from the first image corresponding to the first pose of the placement area 102 (shown in FIG. 5A) and a second set of uniquely identifiable markers 202 can be detected from the second image corresponding to the second pose of the placement area 102 (shown in FIG. 5B). Given that the markers 202 are uniquely identifiable, the first set of uniquely identifiable markers 202 can be matched to the second set of uniquely identifiable markers 202. In other words, for at least some of the uniquely identifiable markers 202 their position in each pose of the placement area 102 can be determined.

Based thereon, a displacement 203 can be calculated for at least some of the uniquely identifiable markers 202. This is illustrated in FIGS. 5A and 5B via the arrows 203-1 and 203-2 which respectively illustrate the position of at two uniquely identifiable markers 202 before and after the pose change.

Further, a respective central perpendicular 204 can be determining for each displacement 203. This is illustrated in FIGS. 5A and 5B via the lines 204-1 and 204-2. Given that the pose change is performed via a rotational motion, the displacements of every point (and consequently of the markers 202 as well) is cut in half by a perpendicular radius. This is based on rationale that a perpendicular radius acting as a perpendicular bisector of a chord, bisects the chord into two equal segments. The central perpendiculars 204 of all displacements 203 intersect at the center of the placement area, which lies in the rotation axis 106.

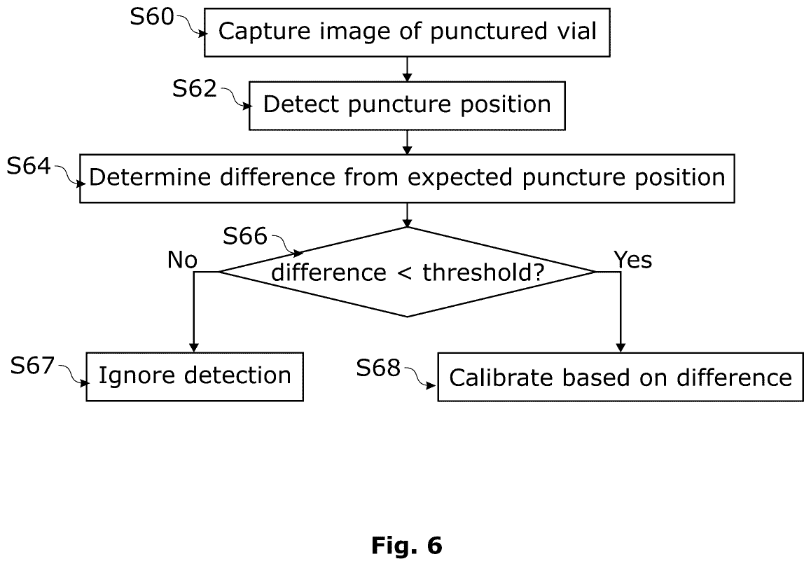

FIG. 6 depicts a flowchart of a method for used to adjusting or calibrating a puncture position. As discussed, the system of FIG. 1 may be part of an autosampler, wherein a needle arm (not shown) may be used to draw the samples from the sample vials 105 disposed in the sample carrier 103. For this, the needle arm may puncture through a lid of the sample vial 105 such that the needle may reach the sample inside the sample vial 105. It can thus be advantageous to calibrate the puncture position of the needle arm such that it can be ensured that the needle arm accurately and successfully punctures the sample vial 105 and draw the sample from within the sample vial 105. Said calibration can also be advantageous to mitigate positional shift of the needle arm.

In S60, the method may comprise capturing an image of a punctured sample vial. The image can be captured using the system of FIG. 1 and/or the method of FIG. 2. In particular, after a puncture of a particular sample vial 105 is made, that particular sample vial 105 can be moved within the field of view 114 of the imaging component 104 such that an image thereof can be captured.

In S62, automatic algorithmic image processing can be used to detect the puncture position. The puncture position can comprise a different contrast from the rest of the lid of the sample vial 105. Thus, e.g., using contrast difference, the puncture position can be determined.

For optimum detection of the puncture position, a specific type of lighting of the sample carrier can be used when taking the image. For example, grazing light can be used for improving the image contrast.

In S64, the detected puncture position can be compared with an expected puncture position. The expected puncture position represents a position wherein the sample vial 105 should be puncture. For example, an expected puncture position may be the center of the lid of the sample vial. The expected puncture position can be determined, e.g., based on the position of the sample carrier in the image, and/or based on the position of the punctured sample vial. A position difference between the detected puncture position and the expected puncture position can be determined. For example, it can be determined how much off-center the detected puncture position is.

In S66, it can be determined whether the detected puncture position is a false positive. That is, the plausibility of the detected puncture position can be checked. This can for example be performed by comparing the position difference determined in S64 with a difference threshold. The difference threshold can be a predetermined parameter. If the difference is small, i.e., smaller than the difference threshold, then most likely the puncture position is correctly detected in S62. In this case, the method may proceed with S68 wherein the puncture position for future punctures is calibrated based on the position difference. However, if the difference is large, i.e., larger than the threshold, then most likely the detected puncture position in S62 is a false positive and is thus ignored in S67.

In S68, calibrating the puncture position may comprise adjusting a position of a sample vial subsequent puncture by a fraction of the determined position difference. That is, the adjustment of the puncture position may be smaller than the puncture difference, preferably smaller than 80% of the puncture difference, further preferably smaller than 60% of the puncture difference, such as smaller than 40% of the puncture difference. For example, in the case of a puncture difference of one millimeter, a correction can be made by 0.3 millimeters, i.e., approximately ⅓ of the deviation. This can avoid overshooting, but may optimize the puncture position over several punctures.

If no insertion positions can be detected, no correction is made. However, a plurality of punctures can typically be determined per sample carrier. Thereby, it can be sufficient if puncture positions are recognized occasionally and corrected.

Adjusting the puncture position can also be realized based on images that may not be taken specifically after each injection. For example, a set of images, either subsequently captured or taken at random can be used. Alternatively, an image taken at the end of a puncture sequence can be used.

This procedure can also be used for an initial adjustment of the puncture positions by means of an appropriately prepared sample carrier.

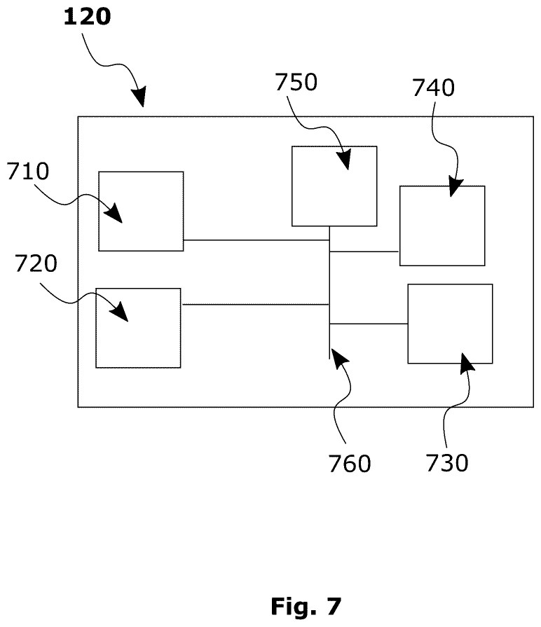

FIG. 7 depicts a processing component 120. The processing component 120 can be a data processing system 120. The processing component 120 can be operatively connected with the imaging component 104 (see FIG. 1). The processing component 120 can thus control the imaging component 104. The processing component can be operatively connected with motion component 130 (see FIG. 1). The processing component 120 can thus control the motion component 130. The processing component 120 can preferably control the imaging component 104 and motion component 130 according to a schedule, i.e., in a synchronized manner. The processing component 120 may access the image data captured by the imaging component 104. The processing component 120 may process the image data to generate an overview image (see FIG. 4) and/or the carrier schematic. For example, the processing component 120 may carry out steps S4 to S16 of the method depicted in FIG. 2. The processing component 120 may also carry out the method depicted in FIG. 3 and/or the method depicted in FIG. 6.

The processing component 120 may comprise a processing unit 750 which may be singular or plural, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programable gate array). The processing unit 750 may comprise one or more micro-controller units.

Further, the processing component 120 may comprise a memory component 740 which may be singular or plural, and may be, but is not limited to, a volatile or non-volatile memory, such as a random-access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

Further, the processing component 120 may comprise an external communication component 730. The external communication component 730 can be configured to send and/or receive data to/from an external device. The external communication component 730 may comprise an antenna (e.g., WIFI antenna, NFC antenna, 4G/3G/4G/5G antenna and the like), USB port/plug, LAN port/plug, contact pads offering electrical connectivity, smart card reader and the like. The external communication component 730 can send and/or receive data based on a communication protocol. Said data can be stored in the memory component 740 and can be executed by the processing unit 750. The external communication component 730 can be connected to the internal communication component 760. Thus, data received by the external communication component 730 can be provided to the memory component 740 and/or to the processing unit 750. Similarly, data stored on the memory component 740 and/or data generated by the processing unit 750 can be provided to the external communication component 730 to be transmitted to an external device.

Further, the processing component 120 may comprise an internal communication component 760 configured to allow the internal components 710-750 of the processing component 120 to communicate with each other. The internal communication component can, for example, comprise a bus connection 760.

The processing component 120 may comprise an input user interface 710 which can allow a user of the processing component 120 to provide at least one input to the processing component 120. For example, the input user interface 710 may comprise a button, keyboard, trackpad, mouse, touchscreen, joystick and the like.

The processing component 120 may comprise an output user interface 720. For example, the output user interface 710 may comprise a display 720. The display 720 can allow the processing component 120 to display the graphical representation generated by the behavior tree editor module 310.

While the present invention has been described with reference to particular embodiments, it is to be understood that these embodiments do not limit the scope of the invention, but merely serve to illustrate the invention.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.

1. A method comprising:
capturing image data with an imaging component, the imaging component configured with a field of view towards a placement area of a platform component, the placement area configured to hold a sample carrier;
processing the image data with a processing component.

2. The method according to claim 1, wherein the sample carrier comprises a plurality of sample vial receptacles, wherein each sample vial receptacle is configured to hold a sample vial and
wherein the method comprises determining, with the processing component, fill status characteristics, each indicative of the presence of a sample vial in a corresponding sample vial receptacle.

3. The method according to claim 1, wherein the method comprises moving the platform component relative to the imaging component according to a motion;
wherein capturing the image data comprises capturing an image sequence comprising a plurality of images, and wherein each image of the image sequence depicts a section of the placement area.

4. The method according to claim 3, wherein the method comprises extracting with the processing component image sections from the image sequence; and
wherein the method comprises combining, with the processing component, the image sections and based thereon generating an overview image.

5. The method according to claim 1, wherein processing the image data comprises generating a top view representation of the sample carrier and
wherein the method comprises the processing component separating the sample carrier from the placement area and/or from background to generate the top view representation of the sample carrier.

6. The method according to claim 5, wherein the method comprises correcting, with the processing component, optical distortions of the image data;
wherein the correcting of the optical distortions of the image data is performed prior to generating the top view representation of the sample carrier.

7. The method according to claim 1, wherein the method comprises generating, with the processing component, a carrier schematic comprising a schematic representation of the sample carrier.

8. The method according to claim 5,
wherein the method comprises generating, with the processing component, a carrier schematic comprising a schematic representation of the sample carrier;
wherein the method comprises generating, with the processing component, the carrier schematic by processing the top view representation of the sample carrier.

9. The method according to claim 7, wherein the method comprises
determining, with the processing component, vial characteristics, each indicative of a property of a corresponding sample vial disposed in the sample carrier and
augmenting, with the processing component, the carrier schematic with at least one of the vial characteristics and generating based thereon an augmented carrier schematic.

10. The method according to claim 2,
wherein the method comprises generating, with the processing component, a carrier schematic comprising a schematic representation of the sample carrier;
wherein the method comprises generating, with the processing component, vial receptacle images, each depicting a top view of a respective sample vial receptacle and
wherein the method comprises incorporating, with the processing component, at least one of the vial receptacle images into the carrier schematic.

11. The method according to claim 4,
wherein the method comprises generating, with the processing component, a carrier schematic comprising a schematic representation of the sample carrier;
wherein the method comprises providing, with the processing component, a combined image comprising the overview image and the carrier schematic.

12. A system comprising
a platform component having a placement area configured to hold a sample carrier;
an imaging component configured with a field of view towards the placement area and configured to capture image data of at least a part of the placement area;
a processing component configured to process the image data; and
wherein the system is configured to carry out the method according to claim 1.

13. An autosampler for a chromatography system, wherein the autosampler comprises the system according to claim 12.

14. A chromatography system comprising the autosampler according to claim 13.
